(19) United States
(12) Patent Application Publication
(10) Pub. No.: US 2008/0007389 A1
(43) Pub. Date: Jan. 10, 2008

(54) Attendee Management Method and Attendee Management System

(76) Inventors: Toshinori Shidou, Tokyo (JP); Taku Yamada, Tokyo (JP); Kenjlro Naemura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/795,116

(22) PCT Filed: Jan. 13, 2006
(86) PCT No.: PCT/JP06/00392

§ 371 Date: Jul. 12, 2007

(30) Foreign Application Priority Data
Jan. 14, 2005 (JP) 2005-007918

(51) Int. Cl. H04Q 3/02

(52) U.S. Cl. 340/10.1

(57) ABSTRACT

A determination is first made on the presence or absence of input of an advance application number as advance application information (S2). Here, when it is determined that the input is present (Y in S2), the advance application number and a reception number as identification information for identifying a wireless tag handed to an attendee, are registered as entrance information in an attendee management table being a database in association with each other (S7 and S14). Meanwhile, when it is determined that the input is absent (N in S2), the reception number is registered as entrance information in the attendee management table (S12 and S14). Hence, it is made possible to hand IC tags to all attendees promptly to complete an entrance reception in a short period of time, and therefore it is possible to smoothly perform the entrance reception.

### TECHNICAL FIELD

The present invention relates to an attendee management method and attendee management system, and particularly relates to an attendee management method and attendee management system capable of easily performing attendee entrance reception processing and exit reception processing.

### BACKGROUND ART

Generally, at an event site such as an exhibition site or a seminar site, attendee entrance and exit are managed. At the entrance reception, entering attendees are registered and at the exit reception, exiting attendees are registered. In order to prevent the attendees from having to wait at the entrance reception and the exit reception, it is necessary to smoothly perform attendee management processing including entrance reception processing and exit reception processing.

Accordingly, there is proposed a system as shown in patent document 1 for the purpose of smoothly performing the entrance reception processing. In such a proposed system, an ID card or the like (for example, a magnetic card or an IC tag) with an attendee Identification code added thereto is sent in advance to an advance applicant together with an invitation card. Then, registration is granted to the advance applicant who brings the ID card by reading the attendee identification code of the ID card, and on the other hand, an attendee, who does not bring an ID card, fills personal information such as a name, a company name and the like in an OCR (Optical Character Reader) form, which is read by an OCR to perform registration. Thereafter, the ID card with an attendee identification code is handed to the attendee (see, for example, JP-A No. 2000-207468 (KOKAI)).

### DISCLOSURE OF THE INVENTION

However, in the aforementioned system, a same-day applicant carries out a procedure in which the applicant fills a name, an address and the like in an OCR form, then waits for a reading operation of the OCR form by the OCR, and receives the ID card. This increases a reception time, resulting in that the same-day applicant has to wait for a considerable time as compared with the advance applicant. Moreover, a proxy for the advance applicant (hereinafter simply referred to as a proxy) is treated in a manner similar to that of the same-day applicant and must carry out the same entrance reception procedure as the case in the same-day applicant, namely, filling the name, the address and the like in the OCR form. Hence, reception time is increased, so that the advance applicant or the proxy who does not bring an invitation card has to wait for a considerable amount of time at the entrance reception although they have already made an application. As mentioned above, the reception time differs depending on the attendees such as the advance applicant, the proxy and the same-day applicant, and therefore it is difficult to smoothly perform the entrance reception to all attendees.

Furthermore, it is important that at the time of exit, a questionnaire survey is conducted concerning exhibits and operation of the held event, to use the result in an event operation to be held next time, to grasp the degree of interest in the exhibits, and to connect the result with future business activities. However, the survey is conducted only in the form of a uniform questionnaire using a paper medium. The questionnaire includes questions concerning seminars which attendees have not attended, and exhibits which they have not viewed, while the number of questions to be answered is large. Consequently, the questionnaires are often left without being answered, even if distributed. Moreover, questionnaires cannot be smoothly collected due to the form of paper medium, resulting in difficulty in performing a smooth exit reception.

The present invention has been made to solve the aforementioned problem. Accordingly, an object of the present invention is to smoothly perform entrance reception and exit reception to all attendees.

In order to achieve the above object, a first aspect according to an embodiment of the present invention is an attendee management method including the steps of determining the presence or absence of input of advance application information issued in advance in association with customer information; receiving input of identification information for identifying a wireless tag handed to an attendee; registering the advance application information and the identification information as entrance information in a database in association with each other when it is determined that the input of the advance application information is present; and registering the identification information as entrance information in the database when it is determined that the input of the advance application information is absent.

A second aspect according to an embodiment of the present invention is an attendee management system including a reception device, and a database including: an input section configured to receive input of advance application information issued in advance in association with customer information and input of identification information for identifying a wireless tag handed to an attendee; a determination means configured to determine the presence or absence of input of advance application information issued in advance in association with customer information; and a registration means configured to register the advance application information and the identification information as entrance information in the database in association with each other when it is determined that the input of the advance application information is present, and register the identification information as entrance information in the database when it is determined that the input of the advance application information is absent.

### BRIEF DESCRIPTION OF THE DRAWINGS

FIG. 1 is a schematic view showing a schematic configuration of an attendee management system according to a first embodiment of the present invention.

FIG. 2 is a block diagram showing a schematic configuration of an information processor in the attendee management system in FIG. 1.

FIG. 3A is an explanatory view showing an attendee management table in the attendee management system in FIG. 1.

FIG. 3B is an explanatory view showing an attendee management table in the attendee management system in FIG. 1.

FIG. 4 is an explanatory view showing a seminar management table in the attendee management system in FIG. 1.

FIG. 5 is an explanatory view showing a seminar content table in the attendee management system in FIG. 1.

FIG. 6 is a flowchart showing the flow of entrance reception processing in the attendee management system in FIG. 1.

FIG. 7 is a plane view showing one display example of an entrance reception screen in the attendee management system in FIG. 1.

FIG. 8 is a plane view showing one display example of an entrance reception screen in the attendee management system in FIG. 1.

FIG. 9 is a flowchart showing the flow of an entrance reception operation performed by an entrance receptionist in the attendee management system in FIG. 1.

FIG. 10 is a flowchart showing the flow of simple-input processing in the attendee management system in FIG. 1.

FIG. 11 is a plane view showing one display example of a simple-input screen in the attendee management system in FIG. 1.

FIG. 12 is a flowchart showing the flow of complete-input processing in the attendee management system in FIG. 1.

FIG. 13 is a plane view showing one example of a complete-input screen in the attendee management system in FIG. 1.

FIG. 14 is a flowchart showing the flow of entrance notification processing in the attendee management system in FIG. 1.

FIG. 15A is a plane view showing a mobile display section of a mobile terminal in the attendee management system in FIG. 1 when an advance applicant himself/herself attends.

FIG. 15B is a plane view showing a mobile display section of a mobile terminal in the attendee management system in FIG. 1 when a proxy attends.

FIG. 16 is a flowchart showing the flow of attendance display processing in the attendee management system in FIG. 1.

FIG. 17 is a plane view showing one display example of an attendee screen in the attendee management system in FIG. 1.

FIG. 18 is a flowchart showing the flow of position notification processing in the attendee management system in FIG. 1.

FIG. 19 is a flowchart showing the flow of seminar reception processing in the attendee management system in FIG. 1.

FIG. 20 is a plane view showing one display example of a seminar reception screen in the attendee management system in FIG. 1.

FIG. 21 is a plane view showing one display example of a message in the attendee management system in FIG. 1.

FIG. 22 is a schematic view showing a schematic configuration of an attendee management system according to a second embodiment of the present invention.

FIG. 23 is an explanatory view showing an exhibition booth visiting history table in the attendee management system in FIG. 22.

FIG. 24 is an explanatory view showing a booth code table in the attendee management system in FIG. 22.

FIG. 25 is an explanatory view showing an exhibit table in the attendee management system in FIG. 22.

FIG. 26 is an explanatory view showing a questionnaire result table in the attendee management system in FIG. 22.

FIG. 27 is an explanatory view showing a table of a questionnaire result database structure corresponding to the questionnaire result table in FIG. 26.

FIG. 28 is a flowchart showing the flow of exhibition booth inner processing in the attendee management system in FIG. 22.

FIG. 29 is a flowchart showing the flow of questionnaire processing in the attendee management system in FIG. 22.

### BEST MODE FOR CARRYING OUT THE INVENTION

### First Embodiment

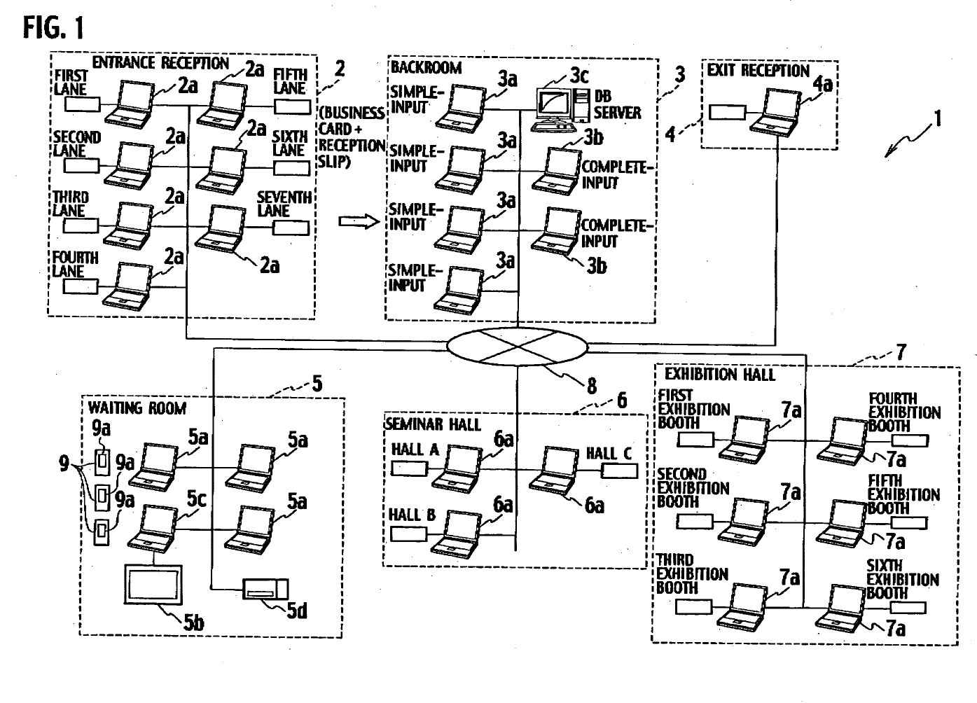

A first embodiment of the present invention will be explained with reference to FIGS. 1 to 21.

As shown in FIG. 1, an attendee management system 1 according to the first embodiment includes an information storage device 3c as a database, and an entrance reception device 2a which: receives input of advance application information (for example, an advance application number) issued in advance in association with customer information, and input of identification information (for example, a reception number) for identifying an IC tag 32 which is a wireless tag handed to the attendee; determines the presence or absence of an input of the advance application information (for example, an advance application number) issued in advance in association with customer information; registers the advance application information and the identification information in an information storage device 3c in association with each other when it is determined that the input of the advance application information is present; and registers the identification information in the information storage device 3c when it is determined that the input of the advance application information is absent.

<Configuration of Attendee Management System>

As shown in FIG. 1, the attendee management system 1 according to the first embodiment is configured in such a way that there are connected to one another via a network 8 as a communication network by wire or wirelessly: an entrance reception processing unit 2 provided in an entrance reception area to perform attendee entrance reception processing and the like; a backroom processing unit 3 provided in a backroom to perform input processing and the like for personal information being a part of customer information (visitor information) on attendees; an exit reception processing unit 4 provided in an exit reception area to perform attendee exit reception processing and the like; a waiting room processing unit 5 provided in a waiting room for salespersons, to perform entrance notification processing, entrance display processing and the like; a seminar processing unit 6 provided in a seminar site to perform seminar reception processing and the like; and an exhibition site processing unit 7 provided in an exhibition site to perform attendee position notification processing and the like.

The entrance reception processing unit 2 includes seven entrance reception devices 2a each provided at each of seven entrance reception lanes where an entrance of the attendee is received. The entrance reception device 2a receives an input operation from an entrance receptionist, who is an operator, and performs entrance reception processing for carrying out attendee entrance reception or search processing, in accordance with the input operation. Incidentally, the entrance reception device 2a functions as a reception device.

The backroom processing unit 3 includes: four simple-input devices 3a for a simple-input that inputs simple information, which is part of attendee personal information; two complete-input devices 3b for a complete-input that inputs complete information (detailed information), which is the entire personal information of the attendee, and an information storage device 3a, which is a database that stores customer information on the attendee for each attendee. The simple-input device 3a receives an input operation from a simple-input operator, who is an operator, and performs simple-input processing for registering simple information in accordance with the input operation, and the complete-input device 3b receives an input operation from a complete-input operator, who is an operator, and performs complete-input processing for registering complete information in accordance with the input operation. Incidentally, the simple-input device 3a and the complete-input device 3b function as an input device.

Here, the simple information is information, which a salesperson serving the attendee wishes to know as soon as possible, and is composed of, for example, an name of the attendee, a company name and a department. Meanwhile, the complete information is composed of, for example, a title, a postal code, an address, a telephone number, a FAX number and an e-mail address, in addition to the simple information. These information items are acquired by an input operation by the operator, in reference to a business card handed from the attendee. The exit reception processing unit 4 includes one exit reception device 4a provided at an exit reception lane where an exit of the attendee is received.

The exit reception processing unit 4a receives an input operation from an exit receptionist, who is an operator, and performs exit reception processing for carrying out exit reception of the attendee in accordance with the input operation.

The waiting room processing unit 5 includes three entrance notification devices 5a provided for salespersons, an attendance display device 5c having a large-scale display 5b with such a size that all salespersons in the waiting room can view, and a printer 5d that prints information of various kinds on a recording medium such as paper. The entrance notification device 5a performs entrance notification processing for notifying the salesperson of the entrance of an attendee, receives an input operation from the salesperson who is an operator, and also performs search processing in accordance with the input operation. The attendance display device 5c performs entrance display processing for displaying customer information of the attendee on the large-scale display 5b. Incidentally, the entrance notification device 5a functions as a notification device and the attendance display device 5c functions as a display device.

The salesperson carries a mobile terminal 9 such as a cellular phone and PDA (Personal Digital Assistants). The mobile terminal 9 is configured to be capable of performing communications with the entrance notification device 5a via the network 8 and has an operation section (not shown) that receives an operation from the salesperson, who is an operator, and a mobile display section 9a that displays information of various kinds.

The seminar processing unit 6 includes three seminar reception devices 6a each provided at, for example, a site A, a site B and a site C, respectively. The seminar reception device 6a receives an input operation from a seminar receptionist, who is an operator, and performs seminar reception processing for receiving a seminar or search processing, in accordance with the input operation. Incidentally, the seminar reception device 6a functions as a display device and an alarm.

The exhibition site processing unit 7 includes six exhibition site devices 7a each provided at, for example, first to sixth exhibition booths, respectively. The exhibition site device 7a receives an input operation from an exhibition guide, who is an operator, or the attendee, and performs position notification processing for notifying an attendee location in accordance with the input operation. Incidentally, the exhibition site device 7a functions as a position registration device and a notification device.

An information processor 10 such as a personal computer (notebook computer, desktop personal computer) is used as the entrance reception device 2a, the simple-input device 3a, the complete-input device 3b, the information storage device 3c, the exit reception device 4a, the entrance notification device 5a, the entrance display 5a, the attendance display device 5c, the seminar reception device 6a, and the exhibition site device 7a.

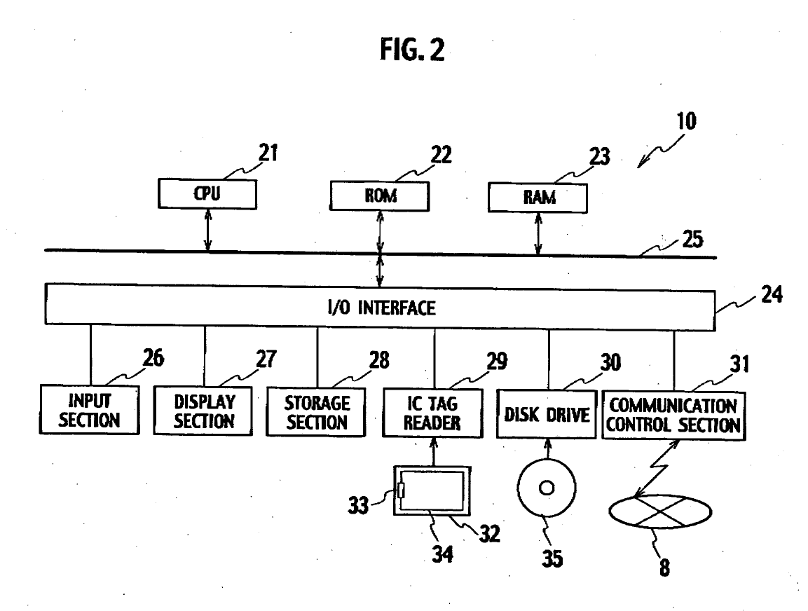

As shown in FIG. 2, the information processor 10 is configured in such a way that a CPU (Central Processing Unit) 21 that controls each component concentratedly, a ROM (Read Only Memory) 22 that stores various kinds of programs executed by the CPU 21, a RAM (Random Access Memory) 23 that functions as a work area and the like for the CPU 21, and an I/O interface 24 are connected to one another to be configured via a bus 25. An input section 26, a display section 27, a storage section 28, an IC tag reader 29, a disk drive 30 and a communication control section 31 are connected to the I/O interface 24.

The CPU 21 reads a boot program from the ROM 22 and executes the program, and further reads an operating system stored in the storage section 28 and executes the system. In addition, the CPU 21 controls each section using input signals from the input section 26, the communication control section 31 and the like and loads a program, data and the like from the ROM 22 and the storage section 28 and the like to the RAM 23, in addition to executing a series of processing such as data computation or processing, using a program command.

The input section 26 includes an input device such as a keyboard, a mouse and the like by which the operator performs input operations of various kinds. The input section 26 creates an input signal according to the operator input operation and transmits the result to the CPU 21 via the I/O interface 24 and the bus 25.

The display section 27 is, for example, a liquid crystal display, a CRT (Cathode Ray Tube) display and the like. The display section 27 receives data from the CPU 21 and displays, for example, a processing result of the CPU 21 using the data.

The storage section 28 is, for example, a magnetic disk device, a semiconductor disk (flash memory) and the like. The storage section 28 stores a program executed by the CPU 21 and various data including display data of various kinds.

The IC tag reader 29 is an IC tag reading section that reads data (for example, a tag ID, which is specific information of the IC tag 32) stored in the IC tag 32 being a wireless tag. The IC tag reader 29 includes an antenna (not shown) for transmitting/receiving a radio wave, through which the IC tag reader 29 transmits/receives the radio wave to/from the IC tag 32 in order to read data from the IC tag 32 in a non-contact manner. This IC tag reader 29 transmits data read from the IC tag 32 to the CPU 21.

The IC tag 32 includes an IC chip 33 and an antenna 34. The IC chip 33 is composed of a CPU, a RAM, a nonvolatile storage section and a communication control section (all of these not shown). In the storage section, a tag ID is prestored as data. It should be noted that the tag ID is a serial number assigned for each IC tag 32 when the IC tag 32 is manufactured. Power is supplied to such an IC tag 32 via the antenna 34 by the radio wave transmitted from the IC tag reader 29. Here, although the IC tag 32 of this embodiment is a proximity IC tag with communication distance of zero to several tens cm, the present invention is not limited to this, for example, an IC tag having communication distance of several meters may be employed. In such a case, the attendee may carry the IC tag 32 without having to place the IC tag 32 on the IC tag reader 29, while an IC tag reader 29 of a gate type may be used.

The disk drive 30 is a data reading device that reads, from a recoding medium 35 such as an optical disk, a flexible disk and the like, data recorded thereon. Such a disk drive 30 reads data from the recording medium 35 and transmits the data to the CPU 21.

The recording medium 35 includes media of various types such as a CD, a DVD and the like, each of which are an optical disk, a magneto-optical disk and a flexible disk. As the disk drive 30, an optical disk device, a magneto-optical disk device, FDD and the like are used, depending on the media type. On such a recording medium 35, various kinds of programs such as an attendee management program are recorded. These programs are read by the disk drive 30 to be installed in the storage section 28. In addition, various kinds of programs such as the attendee management program and the like are not only read from the recording medium 35 to be installed in the storage section 28 but also, for example, may be downloaded from the network 8 and be installed to the storage section 28.

The communication control section 31 is a LAN (Local Area Network) card, a modem, and the like, which controls communication between itself and an external device connected to the network 8 such as the Internet, the LAN and the like wirelessly or by wire. Such a communication control section 31 transmits data received from the external device to the CPU 21 and transmits data from the CUP 21 to the external device.

Additionally, in this embodiment, the simple-input device 3a and the complete-input device 3b of the backroom processing unit 3, and the entrance notification device 5a and the attendance display device 5c of the waiting room processing unit 5 do not have the IC tag reader 29, however, the present invention is not limited to this and these may include the IC tag reader. Moreover, the information processor 10 having the IC tag reader 29 is used as the exhibition site device 7a of the exhibition site processing unit 7, however, the present invention is not limited to this and, for example, only the IC tag reader 29 may be used.

Since the information storage device 3c of the backroom processing unit 3 functions as a database, an attendee management table 51, a seminar management table 52 and a seminar content table 53 are stored in the storage section 28 included in the information storage device 3c.

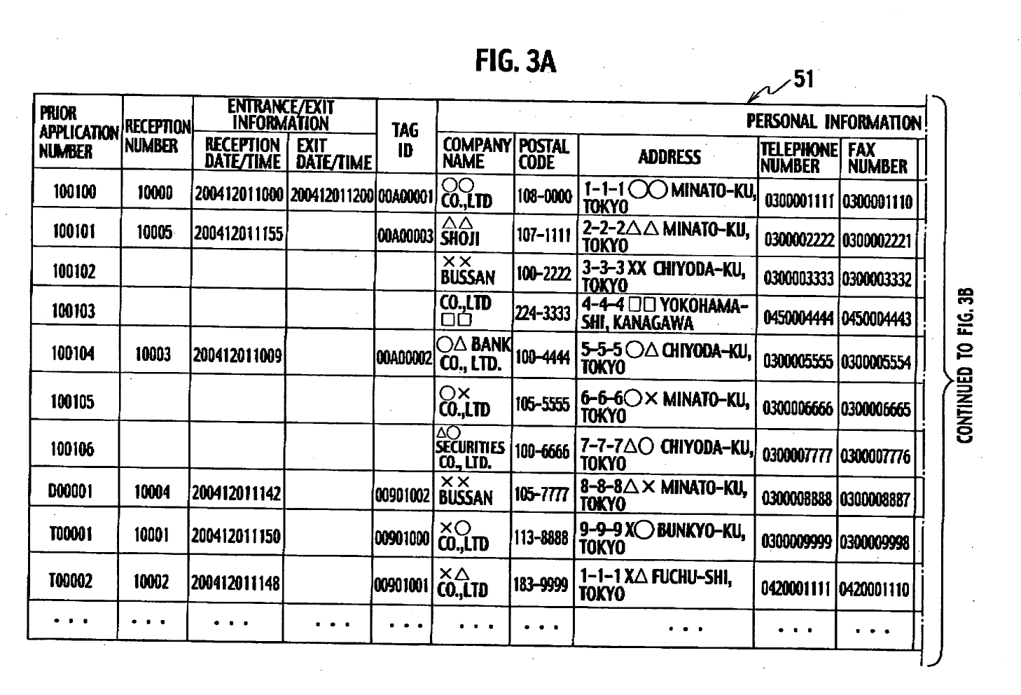

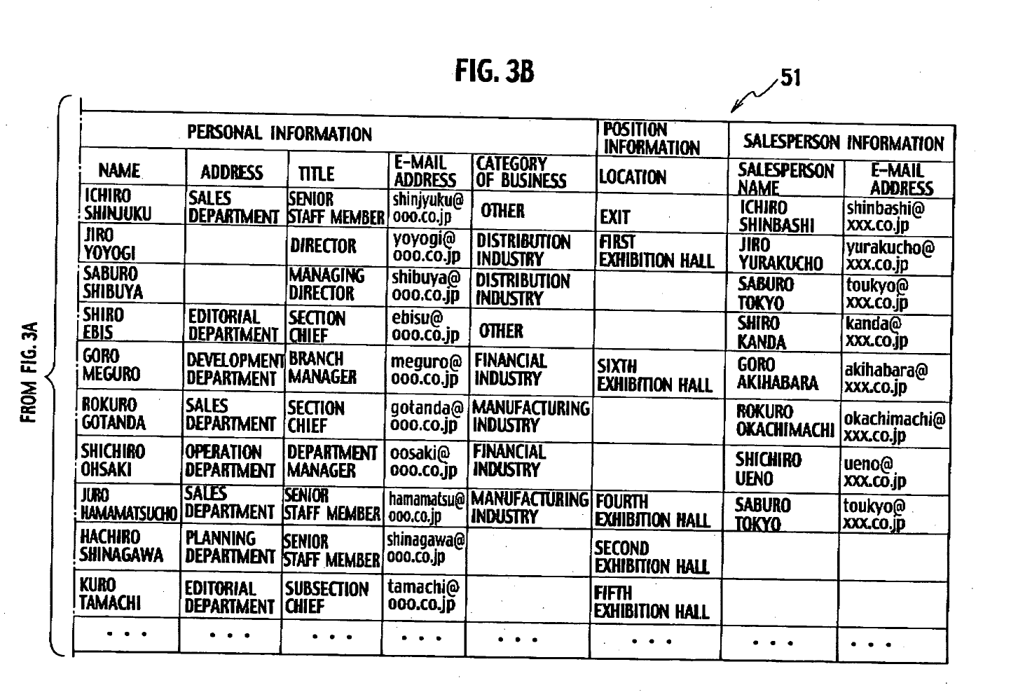

As shown in FIGS. 3A and 3B, customer information (visitor information) is stored in the attendee management table 51 for each attendee. The customer information is composed of: an advance application number (advance application information); a reception number (identification information); entrance/exit information; a tag ID (specific information of the IC tag 32); personal information on attendee (attribute information); position information (location); information on salesperson and the like. The entrance/exit information is composed of entrance reception time/date and exit reception time/date. The personal information on attendee is composed of: a company name; a postal code; an address; a telephone number; a FAX number; a name; a department; a title: an e-mail address; a category of business and the like. The information on salesperson is composed of a salesperson's name and a salesperson's e-mail address. Additionally, in such an attendee management table 51, customer information on the advance applicant (prior registrant) is registered for each advance applicant. Here, the reception number is identification information for identifying the IC tag to be handed to the attendee, and this reception number is smaller than the tag ID in the number of digits and the amount of information. This facilitates the reception number input operation by the entrance receptionist, a simple-input operator and a complete-input operator, making it possible to reduce input operation time.

The advance application number is a number issued (granted) for each advance applicant in advance from the web site when the advance applicant inputs necessary items via the web site and the like. The advance applicant prints out from the web site and brings, an invitation card including the advance application number.

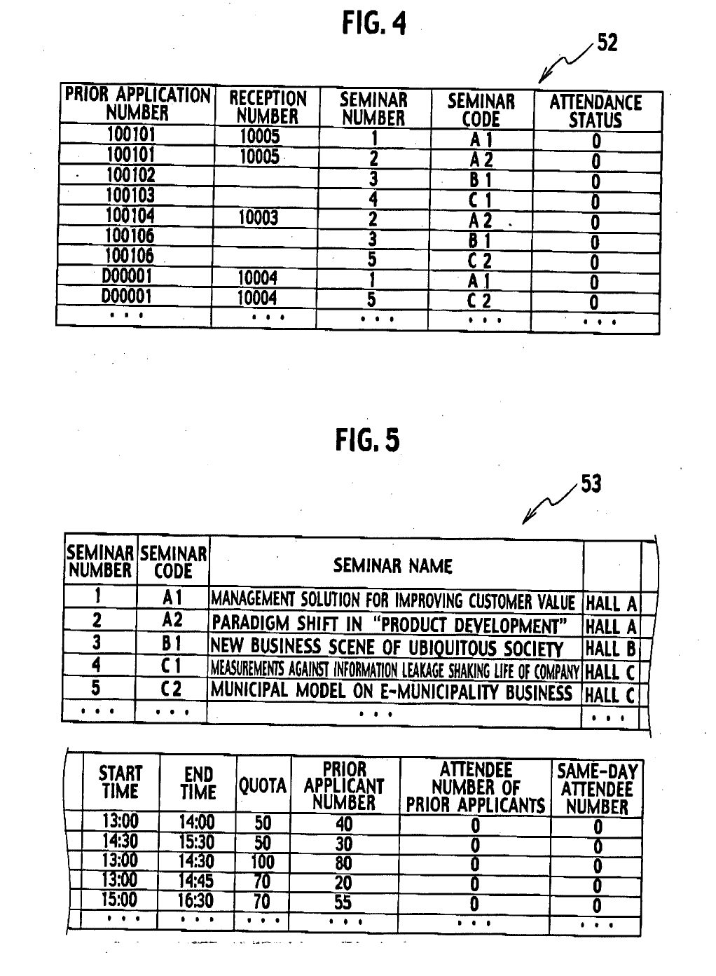

As shown in FIG. 4, in the seminar management table 52, seminar information as part of the customer information is stored for each attendee. The seminar information is composed of an advance application number, a reception number, a seminar number, a seminar code and an attendance status, and is associated with the attendee management table 51 by the advance application number or the reception number. Additionally, in such a seminar management table 52, seminar information on the advance applicant is registered in advance for each advance applicant.

As shown in FIG. 5, in the seminar content table 53, seminar content information as part of the seminar information is stored for each seminar. The seminar content information is composed of a seminar number, a seminar code, a seminar name, a site, start time, end time, quota, the number of advance applicants, the number of attendees of advance applicants, and the number of same-day attendees, and is associated with the seminar management table 52 by the seminar number or the seminar code. Additionally, in such a seminar content table 53, seminar content information is registered in advance for each seminar. Moreover, the quota, the number of advance applicants, the number of attendees of advance applicants, the number of same-day attendees, and the number of vacant seats obtained therefrom are used as vacancy information.

An explanation will be given of processing performed by each of the processing units included in the attendee management system 1 in the aforementioned configuration, that is, each device of the entrance reception processing unit 2, the backroom processing unit 3, the exit reception processing unit 4, the waiting room processing unit 5, the seminar processing unit 6 and the exhibition site processing unit 7, namely, the entrance reception device 2a, the simple-input device 3a, the complete-input device 3b, the exit reception device 4a, the entrance notification device 5a, the attendance display device 5c, the seminar reception device 6a and the exhibition site device 7a.

<Entrance Reception Processing>

First, an explanation will be given of the entrance reception processing performed by the entrance reception device 2a of the entrance reception processing unit 2. The CPU 21 of the entrance reception device 2a executes the entrance reception processing using the attendee management program stored in the storage section 28 of the entrance reception device 2a.

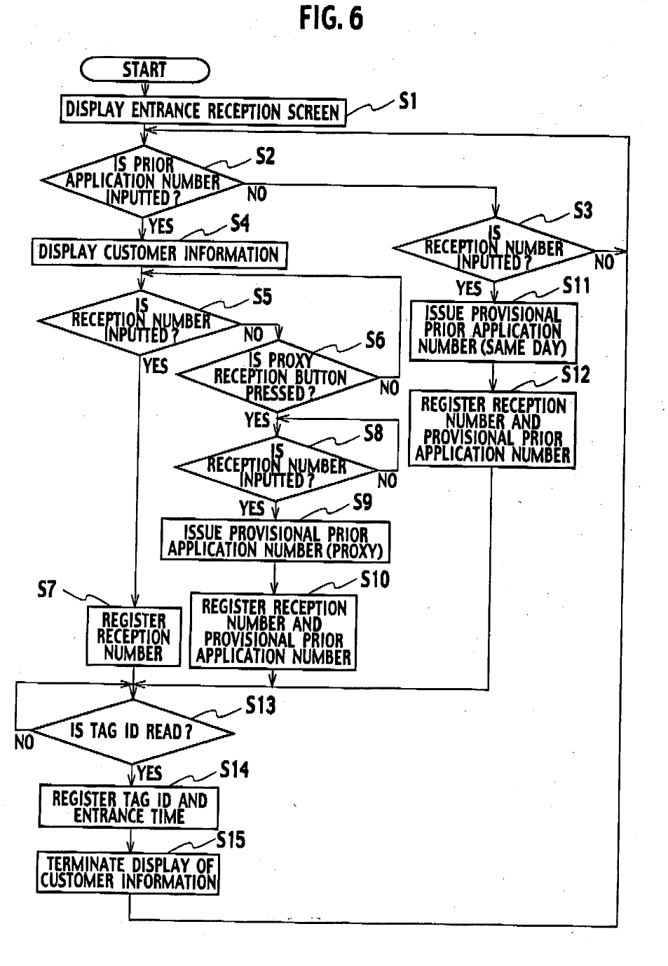

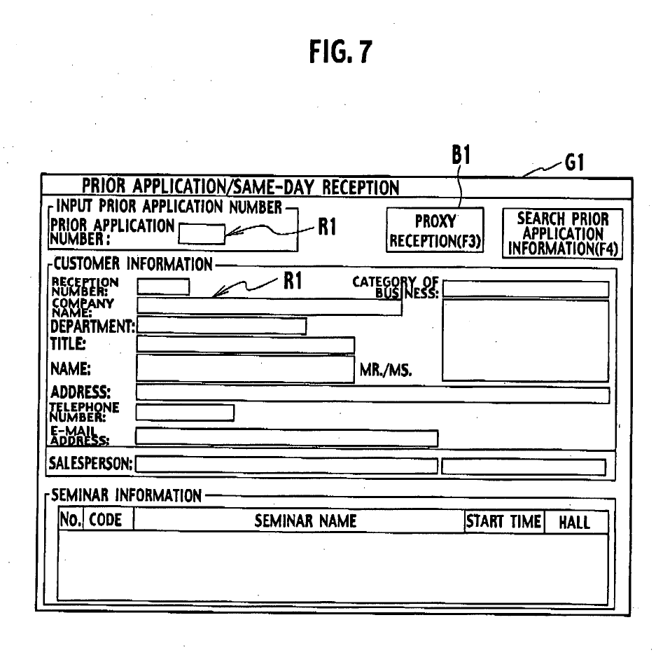

As shown in FIG. 6, the CPU 21 displays an entrance reception screen G1 on the display section 27 of the entrance reception device 2a on starting the entrance reception device 2a. Accordingly, for example, the entrance reception screen G1 as shown in FIG. 7 is displayed. On the entrance reception screen G1, input regions R1 for inputting each of the advance application number and the customer information (visitor information) are provided, and a proxy reception button B1 is also provided for declaring that the attendee is a proxy, namely, for declaring the reception of the proxy. In addition, the proxy reception button B1 may be provided as, for example, a function, key in the input section 26 of the entrance reception device 2a.

Next, the CPU 21 determines whether or not the advance application number is inputted (step S22 determination means), and at the same time determines whether or not the reception number is inputted (step S3), and waits for the input of the advance application number or the input of the reception number by the entrance receptionist (N in step S2 and N in step S3).

When the attendee carries an invitation card (advance applicant or the proxy), the entrance receptionist receives the invitation card including the advance application number and two business cards, and then operates the input section 26 of the entrance reception device 2a to input the advance application number. On the other hand, when the attendee carries no invitation card (same-day applicant), the entrance receptionist receives two business cards and operates the input section 26 of the entrance reception device 2a to input the reception number. Additionally, when the attendee forgets and does not carry the invitation card (advance applicant or the proxy), the entrance receptionist asks the attendee his/her name and sets the name as a searching target, extracts the advance application number from the attendee management table 51, and thereafter inputs the extracted advance application number.

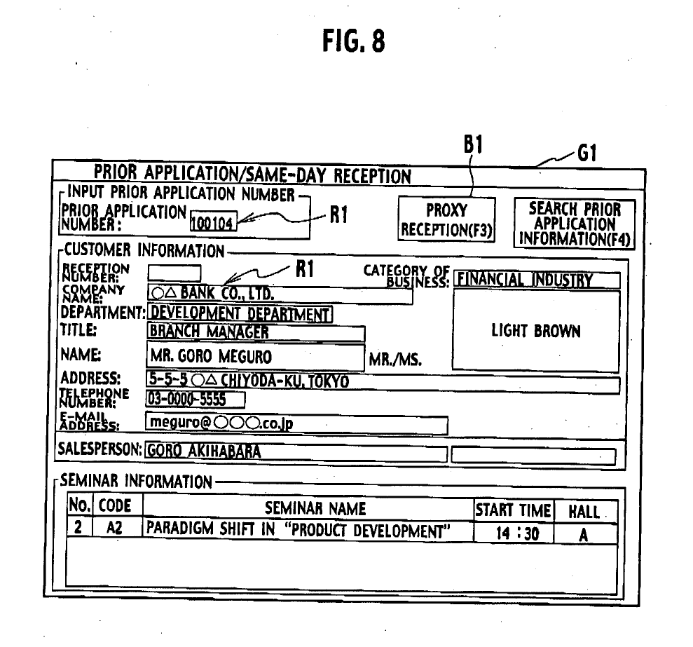

When determining that the advance application number has been inputted by the entrance receptionist (Y in step S2), the CPU 21 displays customer information (visitor information) corresponding to the inputted advance application number, in reference to the attendee management table 51, on the entrance reception screen G1 (step S4). As a result, the entrance reception screen G1 shows a screen as shown in FIG. 8. Here, “100104” is inputted as the advance application number and the corresponding customer information is displayed as shown in FIG. 8.

Thereafter, the CPU 21 determines whether or not the reception number is inputted by the entrance receptionist (step S5), and at the same time determines whether or not the proxy reception button B1 is pressed by the entrance receptionist (step S6: declaration input determination means), and waits for the input of the reception number or the press of the proxy reception button B1 (N in step S5 and N in step S6).

The entrance receptionist compares the entrance reception screen G1 with the business card and checks whether the attendee is an advance applicant or a proxy. When the attendee is an advance applicant, the entrance receptionist operates the input section 26 of the entrance reception device 2a to input the reception number, and when the attendee is not an advance applicant, namely, the attendee is a proxy, the entrance receptionist operates the input section 26 of the entrance reception device 28 to press the proxy reception button B3, and thereafter inputs the reception number.

When determining that the reception number has been inputted by the entrance receptionist in step S5 (Y in step S5), the CPU 21 registers the reception number inputted in step S5, as entrance information (attendance information) in the attendee management table 51 in association with the advance application number inputted in step S2 (step S7: registration means). Here, the entrance information is information indicating that the attendee has entered.

When determining that the proxy reception button B1 has been pressed by the entrance receptionist in step S6 (Y in step S6), the CPU 21 determines whether or not the reception number is inputted by the entrance receptionist (step S5) and waits for the input of the reception number (N in step S8).

When determining that the reception number has been inputted by the entrance receptionist in step S8 (Y in step S8), the CPU 21 issues a provisional advance application number for a proxy (step S9), and additionally registers the provisional application number and the reception number inputted in step S5 as entrance information in the attendee management table 51 in association with each other (step S10: registration means). At this time, in reference to the customer information of the advance applicant, for example, a proxy company name, a telephone number, an address, a department, a salesperson name and an e-mail address are automatically registered, namely, a company name of an advance applicant, a telephone number, an address, a department are copied and automatically registered. In addition, a “D” as an initial indicating that the attendee is a proxy is added to the provisional advance application number for the proxy.

On the other hand, when determining that the reception number has been inputted by the entrance receptionist (Y in step S3), the CPU 21 issues a provisional application number for a same-day applicant (step S11) and additionally registers the provisional application number and the reception number inputted in step S3 as entrance information in the attendee management table 51 in association with each other (step S12: registration means). In addition, a “T” as an initial indicating that the attendee is a same-day applicant is added to the provisional advance application number for the same-day applicant.

Thereafter, the CPU 21 determines whether or not the tag ID is read from the IC tag 32 (step S13) and waits for the reading of the tag ID (N in step S13). When determining that the tag ID has been read (Y in step 613), the CPU 21 registers the tag ID and entrance time in the attendee management table 51 in association with the reception number registered in step 67, step S10 or step S12 (step S14) and terminates the display of the customer information (visitor information) on the entrance reception screen G1 (step S15), and returns processing to step S2.

The entrance receptionist puts one business card and the IC tag 32 in a name holder and the like, lends it to the attendee, and then adheres a reception slip (for example, a Post-it note) with the reception number written to the other business card to hand it to the simple-input operator. At this time, the entrance receptionist may write the reception number on the business card and hand it to the simple-input operator, however, such work takes time and effort, and thus it is preferable to attach the reception slip such as Post-it note with the reception number written to the business card and hand it to the simple-input operator. In addition, the reception slip with a serial number is prepared for each of seven reception lanes, and for example, a top figure of the reception number indicates a reception lane, for example, the reception number “100001” indicates an entrance reception at a first reception lane and the reception number “300001” indicates an entrance reception at a third reception lane.

In this way, when the attendee is an advance applicant, the advance application number, the reception number and the tag ID are registered as entrance information in the attendee management table 51 in association with one another, and when the attendee is a proxy or a same-day applicant, the provisional advance application number, the reception number and the tag ID are registered as entrance information in the attendee management table 51 in association with one another. This makes it possible to speedily hand the IC tags 32 to all attendees such as the advance applicants, the proxies and the same-day applicants and complete the entrance reception in a short period of time. Thus, it is possible to smoothly perform the entrance reception to all attendees.

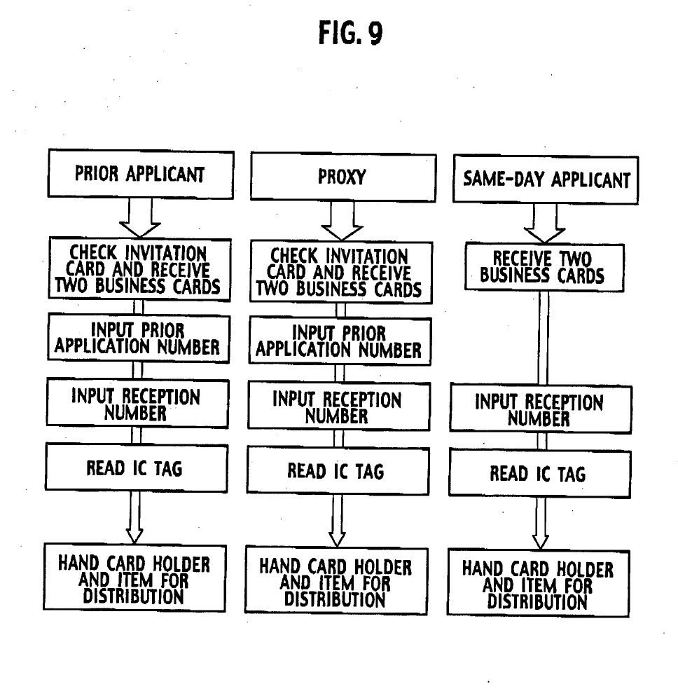

Here, a detailed explanation will be given of an entrance reception operation performed by the entrance receptionist. As shown in FIG. 9, when the attendee is an advance applicant, the entrance receptionist receives the invitation card including the advance application number and two business cards from the advance applicant, operates the input section 26 of the entrance reception device 2a to input the advance application number, inputs the reception number and reads the IC tag 32 using the IC tag reader 29. Thereafter, the entrance receptionist puts one business card and the IC tag 32 in the name holder (card holder) to hand to the attendee, and adheres the reception slip (for example, Post-it note) with the reception number written to the other business card to hand to the simple-input operator.

Similarly, when the attendee is a proxy, the entrance receptionist receives the invitation card including the advance application number and two business cards from the proxy, operates the input section 26 of the entrance reception device 2a to input the advance application number, inputs the reception number and reads the IC tag 32 using the IC tag reader 29. After that, the entrance receptionist puts one business card and the IC tag 32 in the name holder (card holder) and hands it to the attendee, and adheres the reception slip (for example, Post-it note) with the reception number written to the other business card to hand to the simple-input operator.

Additionally, when the attendee is a same-day applicant, the entrance receptionist receives two business cards from the same-day applicant, operates the input section 26 of the entrance reception device 2a to input the reception number, and reads the IC tag 32 using the IC tag reader 29. Thereafter, the entrance receptionist puts one business card and the IC tag 32 in the name holder (card holder) and hands it to the attendee, and adheres the reception slip (for example, Post-it note) with the reception number written to the other business card to hand to the simple-input operator.

In this way, the entrance receptionist can perform the same entrance reception operation to any attendee such as the advance applicant, the proxy, and the same-day applicant. Hence the entrance reception is completed by simplifying the entrance reception operation, and therefore it is possible to promptly perform the entrance reception to all attendees.

<Simple-Input Processing>

An explanation will be next given of simple-input processing performed by the simple-input device 3a of the backroom processing unit 3. The CPU 21 of the simple-input device 3a executes simple-input processing using the attendee management program stored in the storage section 28 of the simple-input device 3a.

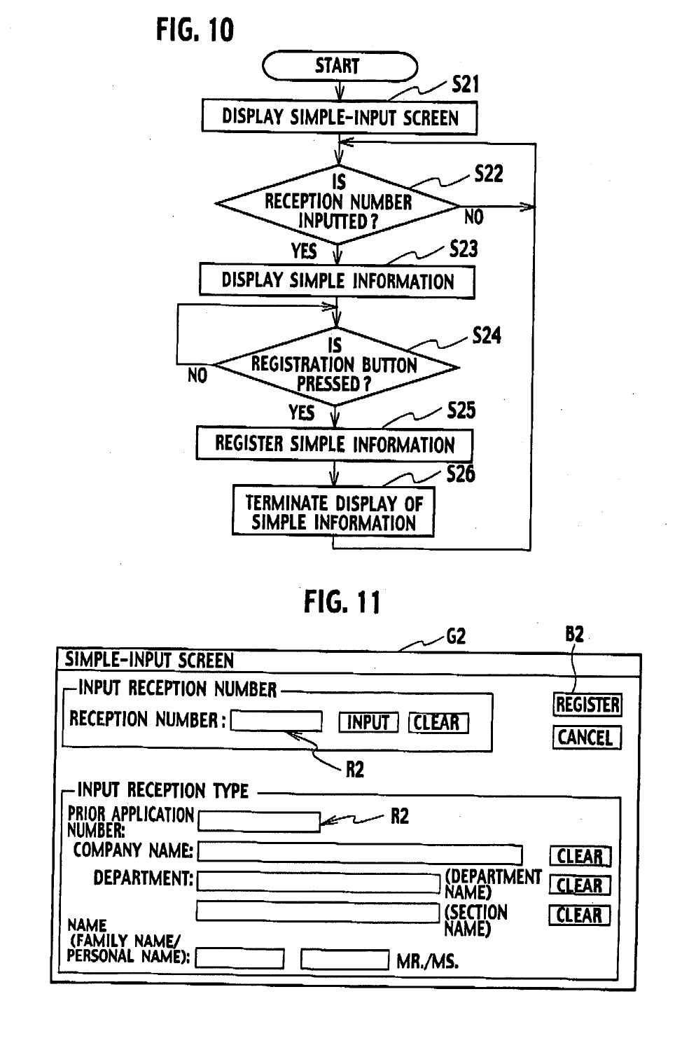

As shown in FIG. 10, the CPU 21 first displays a simple-input screen G2 on the display section 27 of the simple-input device 3a on starting the simple-input device 3a (step S21). As a result, for example, the simple-input screen G2 as shown in FIG. 11 is displayed. On the simple-input screen G2, input regions R2 for inputting the reception number and the simple information are provided and a registration button B2 is also provided for declaring that the simple information is registered in the attendee management table 51. In addition, the registration button B2 may be provided as, for example, a function key in the input section 26 of the simple-input device 3a.

Next, the CPU 21 determines whether or not the reception number is inputted by the simple-input operator (step S22) and waits for the input of the reception number by the simple-input operator (N in step S22).

Upon receipt of the business card with the reception slip adhered thereon from the entrance receptionist, the simple-input operator operates the input section 26 of the simple-input device 3a to input the reception number in reference to the reception slip.

When determining that the reception number has been inputted by the simple-input operator (Y in step S22), the CPU 21 displays the simple information as part of attendee management information corresponding to the inputted reception number, on the simple-input screen G2 in reference to the attendee management table 51 (step S23).

At this time, when the attendee is an advance applicant, the company name, the department and the name are displayed as simple information on the simple-input screen G2, when the attendee is a proxy, the company name and the department of the advance applicant are displayed as simple information on the simple-input screen G2, and when the attendee is a same-day applicant, no simple information is displayed on the simple-input screen G2.

Thereafter, the CPU 21 determines whether or not the simple-input operator presses the registration button B2 (step S24), and waits for the press of the registration button B2 (N in step S24).

The simple-input operator operates the input section 26 of the simple-input device 3a in reference to the business card handed from the entrance receptionist and checks/corrects the simple information displayed on the simple-input screen G2 or inputs the name of the attendee, the company name and the department as simple information, and thereafter presses the registration button B2.

When determining that the simple-input operator has pressed the registration button B2 (Y in step S24), the CPU 21 registers the checked/corrected or inputted simple information as customer information in the attendee management table 51, in association with the reception number inputted in step S22 (step S25), terminates the display of the simple information on the simple-input screen G2 (step S26), and returns processing to step S22.

As a result, part of the attendee personal information is promptly registered as customer information in the attendee management table 51 for each attendee. Thereafter, the simple-input operator hands the business card, to which the reception slip (for example, Post-it note) is adhered, to the complete-input operator.

In this way, since part of the attendee personal information is registered in the attendee management table 51 after the entrance reception, entrance reception processing at the entrance reception and the entrance reception operation by the entrance receptionist are reduced to make it possible to smoothly perform the entrance reception to the attendee. Moreover, part of the attendee personal information that the salesperson needs is registered in the attendee management table 51 immediately after the entrance reception, and therefore it is possible to use the information promptly.

<Complete-Input Processing>

An explanation will be next given of complete-input processing performed by the complete-input device 3b of the backroom processing unit 3. The CPU 21 of the complete-input device 3b executes complete-input processing using the attendee management program stored in the storage section 28 of the complete-input device 3b.

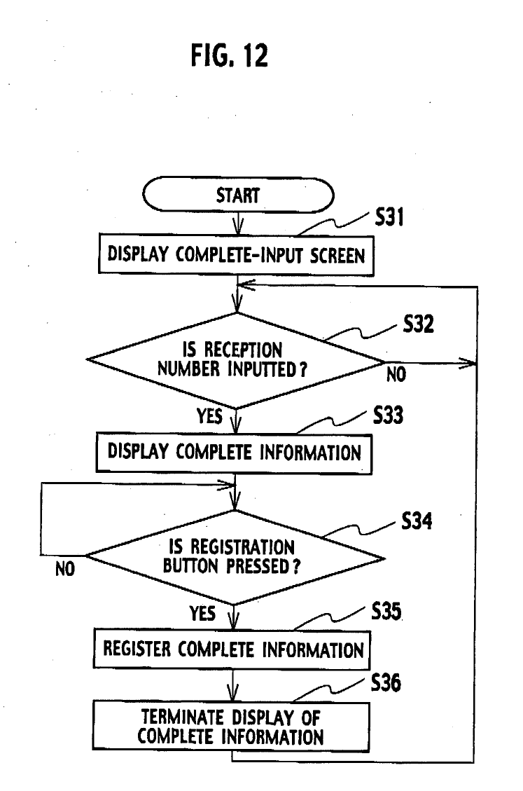

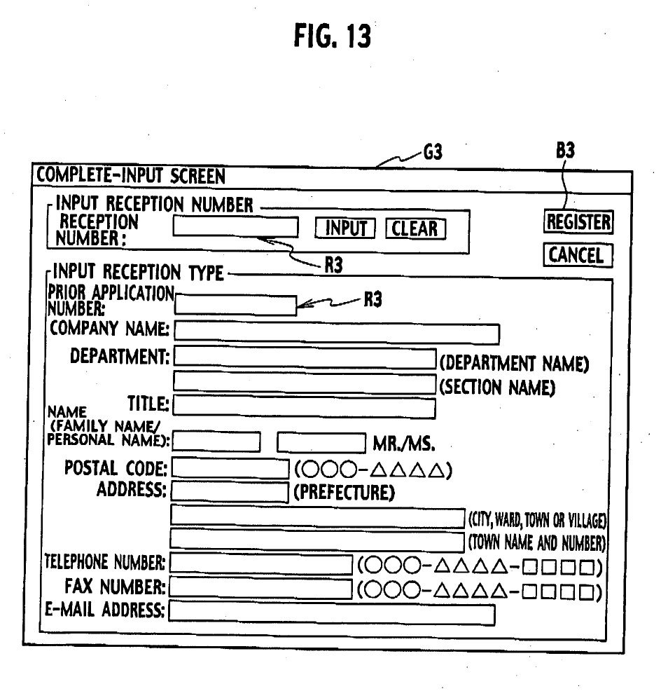

As shown in FIG. 12, the CPU 21 first displays a complete-input screen G3 on the display section 27 of the complete-input device 3b on starting the complete-input device 3b (step S31). As a result, for example, the complete-input screen G3 as shown in FIG. 13 is displayed. On the complete-input screen G3, input regions R3 for inputting each of the reception number and the complete information are provided, and a registration button B3 for declaring that the complete information is registered in the attendee management table 51 is also provided. In addition, the registration button B3 may be provided as, for example, a function key in the input section 26 of the complete-input device 3b.

Next, the CPU 21 determines whether or not the reception number is inputted by the complete-input operator (step S32) and waits for the input of the reception number by the simple-input operator (N in step S32).

The complete-input operator receives the business card, to which the reception slip is adhered, from the simple-input operator, and operates the input section 26 of the complete-input device 3b to input the reception number in reference to the reception slip.

When determining that the reception number has been inputted by the complete-input operator (Y in step S32), the CPU 21 displays the complete information as part of attendee management information corresponding to the inputted reception number on the complete-input screen G3 in reference to the attendee management table 51 (step S33).

At this time, when the attendee is an advance applicant, the company name, the department, the title, the name, the postal code, the address, the telephone number and the FAX number are displayed as complete information on the complete-input screen G3, and when the attendee is a proxy, the advance applicants company name, department, postal code, address, telephone number and FAX number are displayed as simple information on the complete-input screen G3, and when the attendee is a same-day applicant, only the simple information including the name of the attendee, the company name and the department is displayed on the complete-input screen G3.

Thereafter, the CPU 21 determines whether or not the complete-input operator presses the registration button B3 (step S34), and waits for the press of the registration button B3 (N in step S34).

The complete-input operator operates the input section 26 of the simple-input device 3b in reference to the business card handed from the simple-input operator and checks/corrects the complete information displayed on the complete-input screen G3 or inputs all of the company name, the department, the title, the name, the postal code, the address, the telephone number, the FAX number, and the e-mail address, and thereafter presses the registration button B3.

When determining that the complete-input operator has pressed the registration button B3 (Y in step S34), the CPU 21 registers the checked/corrected or inputted complete information as customer information in the attendee management table 51 in association with the reception number inputted in step S32 (step S35), terminates the display of the complete information on the complete-input screen G3 (step S36), and returns processing to step S32.

As a result, all of the attendee personal information is registered as customer information in the attendee management table 51 for each attendee.

Accordingly, since all of the attendee personal information is registered in the attendee management table 51 after the entrance reception, entrance reception processing at the entrance reception and the entrance reception operation by the entrance receptionist are reduced to make it possible to smoothly perform the entrance reception to the attendee. Moreover, all of the attendee personal information are registered in the attendee management table 51 during the period in which the exhibition is held, and therefore it is possible to use the information promptly such as sending a thank-you note by e-mail.

<Entrance Notification Processing>

An explanation will be next given of entrance notification processing performed by the entrance notification device 5a of the waiting room processing unit 5. The CPU 21 of the entrance notification device 5a executes entrance notification processing using the attendee management program stored in the storage section 28 of the entrance notification device 5a.

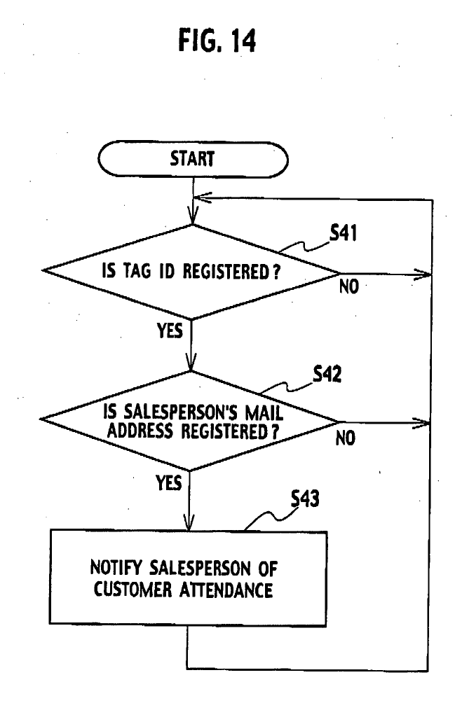

As shown in FIG. 14, the CPU 21 determines whether or not the tag ID is registered in the attendee management table 51 (step S41) and waits for the registration of the tag ID (N in step S41). When determining that the tag ID has been registered in the attendee management table 51 (Y in step S41), the CPU 21 determines, in reference to the customer information corresponding to the registered tag ID, whether or not a salesperson's e-mail address is registered (step S42).

When determining that no salesperson's e-mail address has been registered (N in step S42), the CPU 21 returns processing to step S41, On the other hand, when determining that the salesperson's e-mail address has been registered (Yin step S42), the CPU 21 notifies the salesperson of entrance of the attendee (customer) to be served (step S43) and returns processing to step S41.

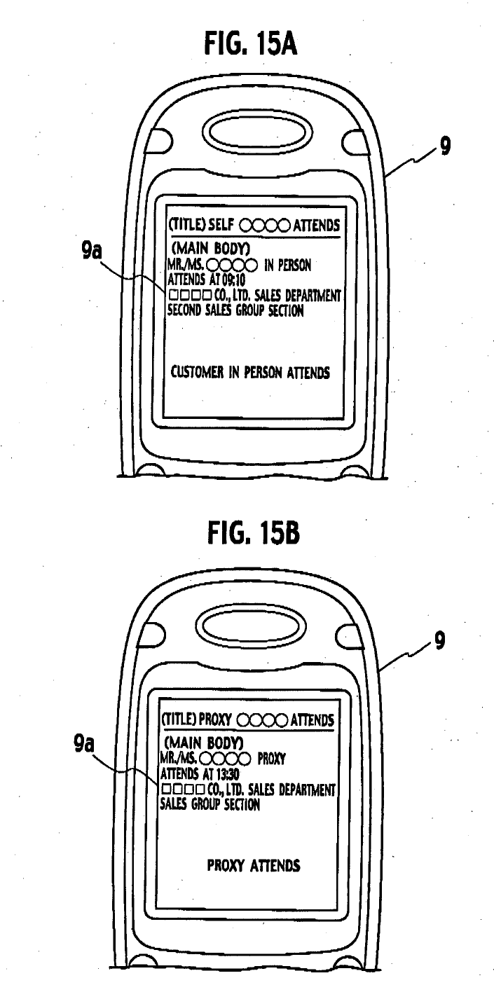

In step S43, in reference to the attendee management table 51, e-mail notifying the entrance of the attendee to be served is transmitted to the mobile terminal 9 that the salesperson carries. As a result, for example, information such as the name, the person himself/herself (advance applicant) or the proxy, entrance time, the company name and the department is displayed on the mobile display section 9a of the mobile terminal 9 as shown in FIGS. 15A and 15B. The attendance of the advance applicant himself/herself and the attendance of the proxy are particularly shown as can be seen in FIG. 15A and FIG. 15B.

Thus, since the salesperson is promptly notified of the entrance of the attendee to be served, that is, immediately after the entrance reception, the salesperson can speedily deal with the entrance of the attendee to be served, so that it is possible to guide the attendee promptly. Moreover, since it becomes possible to know whether the attendee is an advance applicant or a proxy, it is possible to easily search and meet the attendee promptly to guide the attendee.

Additionally, the entrance notification device 5a sets, for example, the salesperson name, the name of the attendee and the like as a searching target to execute search processing in accordance with the input operation by the salesperson. This makes it possible for the salesperson to acquire only the customer information of the attendee to be served and acquire only the customer information of the attendee whom the salesperson wishes to know, and therefore it is possible to deal with the attendee more speedily.

<Entrance Display Processing>

An explanation will be next given of entrance display processing performed by the entrance display device 5c of the waiting room processing unit 5. The CPU 21 of the entrance display device 5c executes entrance display processing using the attendee management program stored in the storage section 28 of the entrance display device 5c.

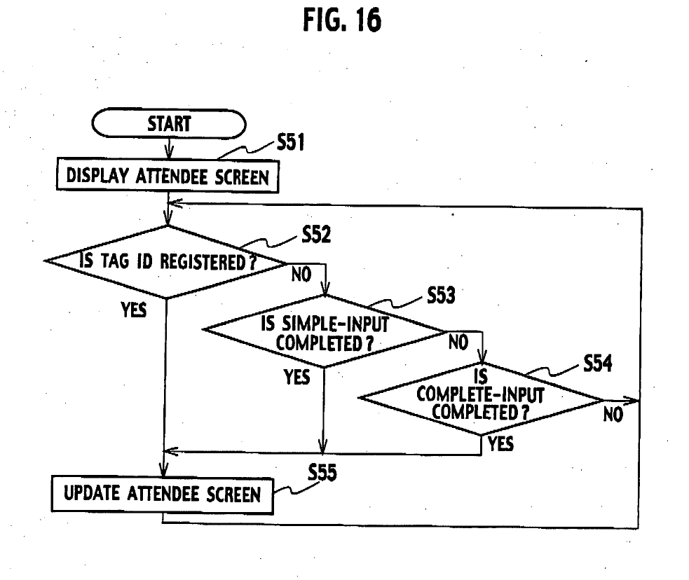

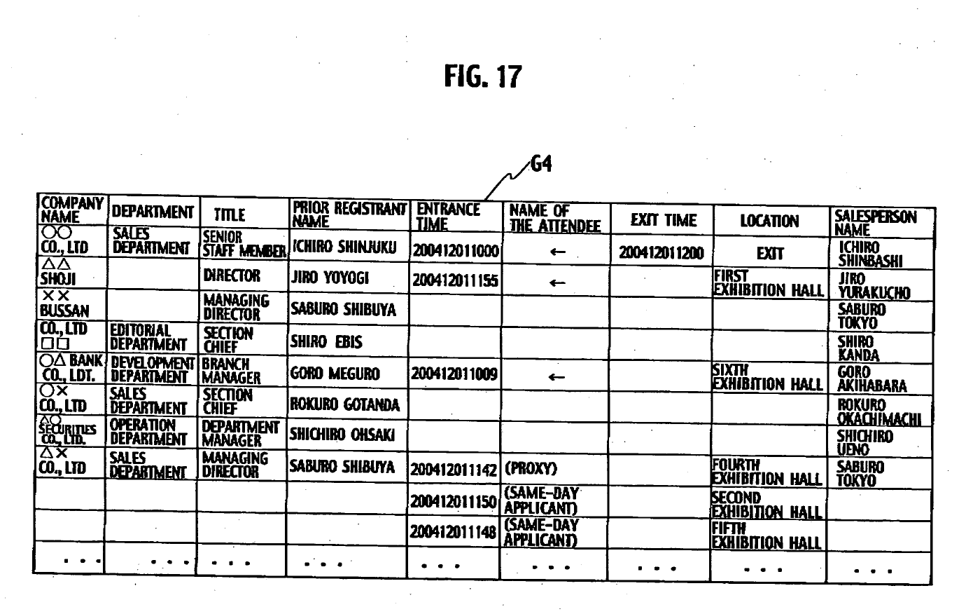

As shown in FIG. 16, the CPU 21 first displays an attendee screen G4 on the large-scale display 5b of the entrance display device 5c in reference to the entrance management table 51 on starting the attendee display device 5c (step S51). As a result, for example, the attendee screen G4 as shown in FIG. 17 is displayed. On the attendee screen G4, the company name, the department, the title, the advance applicant name, the entrance time, the name of the attendee, exit time, the location and the salesperson name are displayed. Additionally, regarding the name of the attendee, “←” is displayed as the advance applicant himself/herself or “(proxy)” or “(same-day application) is displayed until the input operation using the simple-input device 3a is completed.

Next, the CPU 21 determines whether or not the tag ID is registered in the attendee management table 51 (step S52), determines whether or not the simple-input is completed (step S53), further determines whether or not the complete-input is completed (step S54), and waits for the completion of the simple-input and that of the complete-input (N in step S52, N in step S53, and N in step S54). It should be noted that the completion of the simple-input is determined by the press of the registration button B2 in the simple-input screen G2 (see FIG. 11), and the completion of the complete-input is determined by the press of the registration button B3 in the complete-input screen (see FIG. 13).

When determining that the tag ID has been registered in the attendee management table 51 (Y in step S52) or determining that the simple-input has been completed (Y in step S53), or determining that the complete-input has been completed (Y in step S54), the CPU 21 updates the attendee screen G4 in reference to the attendee management table 51 (step S55).

Here, when the simple-input is completed, the name of the attendee is displayed in place of the “(proxy)” in the case where the attendee is a proxy and the name of the attendee is displayed in place of “(same-day application) in the case where the attendee is a same-day applicant, and in addition to this, the company name and the department are displayed. Meanwhile, when the complete-input is completed, the title is displayed in addition to the company name and the department in the case where the attendee is a proxy or a same-day applicant.

In this way, since the salesperson in the waiting room is notified promptly, that is, immediately after the entrance reception that the attendee to be served enters, the salesperson can speedily deal with the entrance of the attendee to be served, so that it is possible to guide the attendee promptly. Moreover, since it becomes possible to know whether the attendee is an advance applicant or a proxy, it is possible to easily search and meet the attendee promptly to guide the attendee. Furthermore, the customer information is updated in real-time performance even after the entrance reception, and therefore the salesperson can acquire the latest information.

<Position Notification Processing>

An explanation will be next given of position notification processing performed by the exhibition site device 7a of the exhibition site processing unit 7. The CPU 21 of the exhibition site device 7a executes position notification processing using the attendee management program stored in the storage section 28 of the exhibition site device 7a.

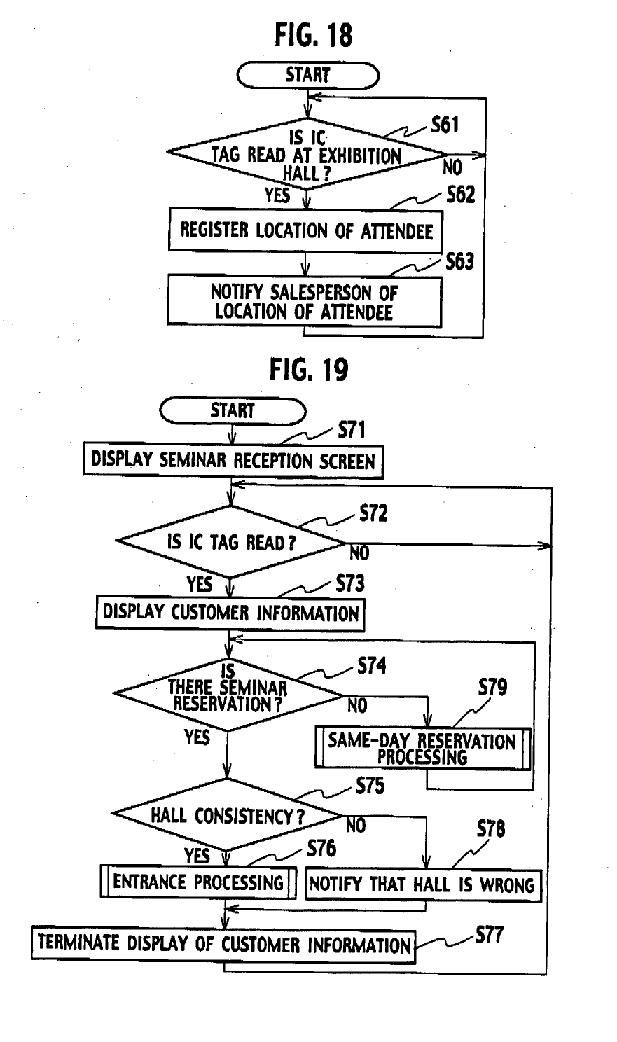

As shown in FIG. 18, the CPU 21 determines whether or not the tag ID 32 is read by the exhibition site device 7a (step S61), and waits for the reading of the IC tag 32 (N in step S61).

When determining that the IC tag 32 has been read (Y in step S61), the CPU 21 registers the read exhibition site as a location of the attendee in the attendee management table 51 (step S62). Accordingly, since the location of the attendee is registered in the attendee management table 51, the location of the attendee is updated each time and displayed on the attendee screen G4 (see FIG. 17).

After that, the CPU 21 notifies the salesperson of the location of the attendee (step S63). At this time, e-mail for reporting the location of the attendee to be served is transmitted to the mobile terminal 9, which the salesperson carries.

In this way, the salesperson is informed of the location of the attendee (position information) and the salesperson can grasp in which exhibition site the attendee to be served is, and therefore it is possible to easily search and meet the attendee promptly to guide the attendee.

<Seminar Reception Processing>

An explanation will be next given of seminar reception processing performed by the seminar reception device 6a of the seminar processing unit 6. The CPU 21 of the seminar reception device 6a executes seminar reception processing using the attendee management program stored in the storage section 28 of the seminar reception device 6a.

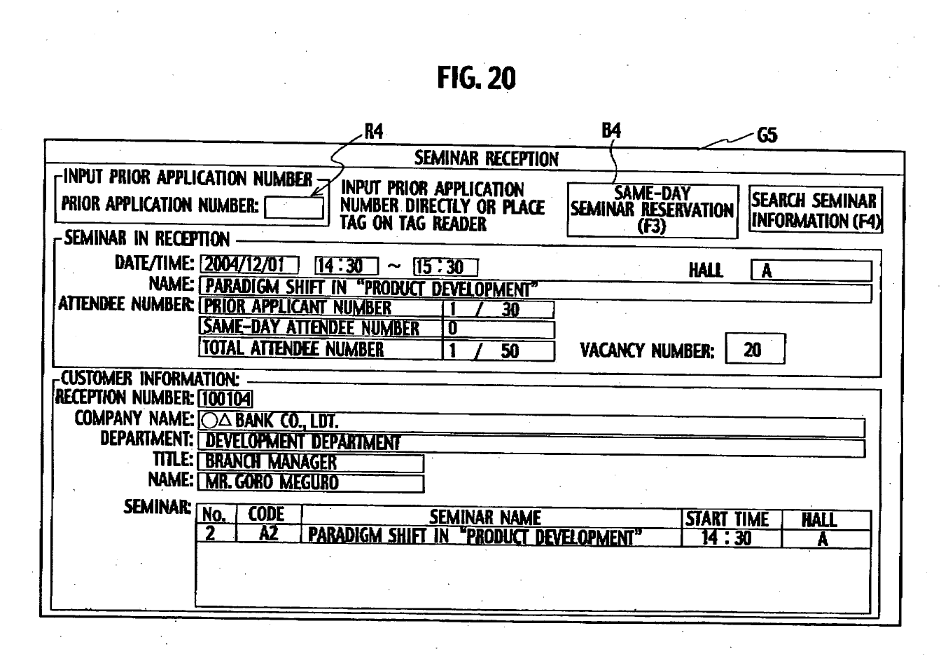

As shown in FIG. 19, the CPU 21 first displays a seminar reception screen G5 on the display section 27 of the seminar reception device 6a on starting the seminar reception device 6a (step S71). As a result, for example, the seminar reception screen G5 as shown in FIG. 20 is displayed. On the seminar reception screen G5, seminar content information in reception and the number of vacant seats are displayed, and an input region R4 for inputting an advance application number and a same-day seminar reservation button B4 declaring that a same-day seminar reservation is performed is provided thereon. The seminar receptionist operates the input section 26 of the seminar reception device 6a to input the advance application number in the input region R4, and press the same-day seminar reservation button B4. In addition, the same-day seminar reservation button B4 may be provided as, for example, a function key in the input section 26 of the seminar reception device 6a.

Next, the CPU 21 determines whether or not the IC tag 32 is read by the seminar reception device 6a (step S72) and waits for the reading of the IC tag 32 (N in step S72).

The seminar receptionist receives the IC tag 32 from the attendee, or alternatively, the attendee himself/herself places the IC tag 32 close to the IC tag reader 29 of the seminar reception device 6a. As a result, the tag ID is read from the IC tag 32.

When determining that the IC tag 32 has been read (Y in step S72), the CPU 21 displays customer information (visitor information) corresponding to the tag ID read from the IC tag 32, on the seminar reception screen G5 (step S73). As a result, the visitor information is displayed on the seminar reception screen G5.

Thereafter, the CPU 21 determines whether or not a seminar reservation is made in reference to the customer information corresponding to the read tag ID (step S74). When determining that the seminar reservation has been made (Y in step S74), the CPU 21 determines whether or not the site in which the attendee enters (site where the attendee is present) is consistent with the reserved site (site where the seminar reserved by the attendee is held) (step S75: site determination means).

When determining that the site in which the attendee enters is consistent with the reserved site (Y in step S75), the CPU 21 performs entrance processing (step S76), terminates the display of the customer information (visitor information) in the seminar reception screen G5 (step S77), and returns processing to step S72.

In the entrance processing, the CPU 21 registers an attendance status in the seminar management table 52 in association with the reception number corresponding to the read tag ID, and updates the number of attendees of advance applicants in the seminar content table 53. At this time, the display of the number of attendees of advance applicants in the seminar reception screen G5 is updated and the total number of attendees is also changed. Additionally, FIG. 20 shows, for example, that the number of advance applicants is 30, that one of them has entered the seminar site, that the number of attendees on the same day is zero, and as a result, that the total number of attendees is one (seating capacity of the seminar site is 50) and that the number of vacant seats is 20. The number of vacant seats is reduced in accordance with the number of attendees on the same day.

When determining that the site in which the attendee enters is not consistent with the reserved site (N in step S75), the CPU 21 notifies that the seminar site is wrong (step S78: notification means), terminates the display of the customer information (visitor information) in the seminar reception screen G5 (step S77), and returns processing to step S72.

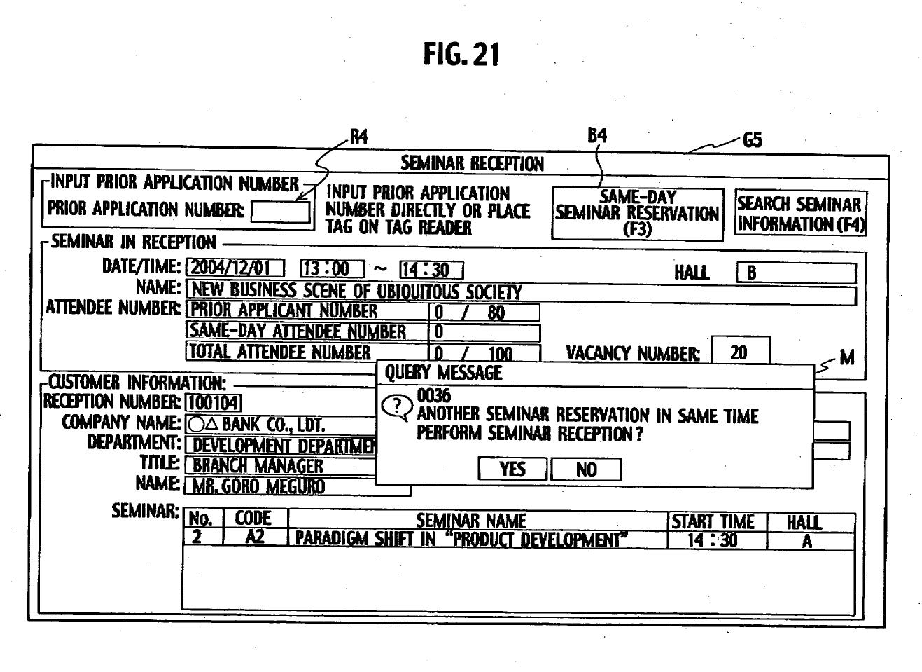

In step S78, for example, as shown in FIG. 21, the CPU 21 displays a message M indicating that another seminar is reserved in the same time period on the seminar reception screen G5, thereby notifying that the seminar site is wrong.

On the other hand, when determining that the seminar is not reserved (N in step S74), the CPU 21 performs same-day reservation processing (step S79) and returns processing to step S73.

In the same-day reservation processing, the CPU 21 waits for the press of the same-day reservation button B4, then, in response to the press of the button, additionally registers the advance application number (provisional advance application number), the reception number, the seminar number, the seminar code and the attendance status as a same-day reservation in the seminar management table 52 in association with the read tag ID, and subsequently updates the number of advance applicants in the seminar content table 53. Additionally, in the same-day reservation processing, when permitting the attendee to enter in the seminar site directly without performing the same-day seminar reservation, the CPU 21 updates the number of same-day attendees in the seminar content table 53.

In this way, the seminar receptionist can view the seminar reception screen G5 to acquire seminar information on the attendee. Moreover, it is possible to grasp vacancy information such as the number of attendees of advance applicants and the number of vacant seats, making it easier to determine whether or not to allow an attendee, who has not made reservation, to attend the seminar, thereby allowing more attendees to attend the seminar.

<Exit Reception Processing>

Finally, an explanation will be given of exit reception processing performed by the exit reception device 4a of the exit reception processing unit 4. The CPU 21 of the exit reception device 4a executes exit reception processing using the attendee management program stored in the storage section 28 of the exit reception device 4a.

The CPU 21 first displays an exit reception screen on the display section 27 of the exit reception device 4a on starting the exit reception device 4a and waits for the reading of the IC tag 32. When the IC tag 32 is read, the CPU 21 registers exit time in the attendee management table 51 in association with the tag ID read from the IC tag 32.

Thus, when the exit time is registered in the attendee management table 51, the exit time is displayed on the large-scale display 5b (see FIG. 17), allowing the salesperson to know the exit of the attendee.

<Effect of First Embodiment>

As explained above, according to the first embodiment, when the attendee is an advance applicant, the advance application number as advance application information and the reception number as identification information for identifying the IC tag 32 to be handed to the attendee are registered as entrance information in the information storage device 3c being the database, in association with each other. When the attendee is a proxy or a same-day applicant, the reception number is registered as entrance information in the information storage device 3c. This makes it possible to hand the IC tags to all attendees promptly to complete an entrance reception in a short period of time, and therefore it is possible to smoothly perform the entrance reception to all attendees.

### Second Embodiment

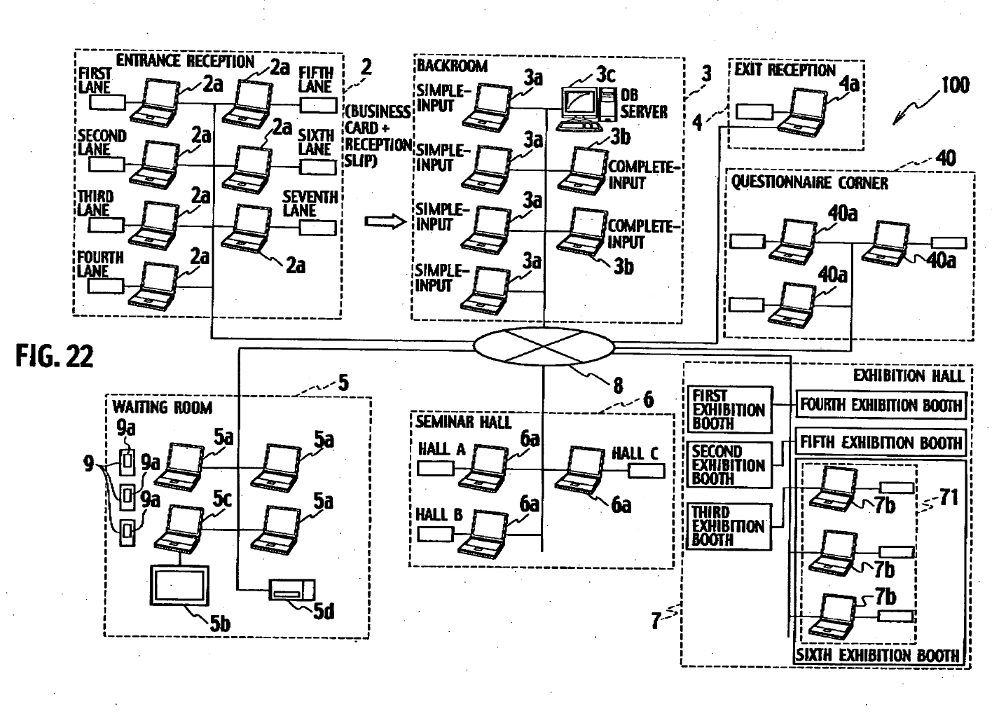

A second embodiment of the present invention will be explained with reference to FIGS. 22 to 29.

Parts of the second embodiment different from those of the first embodiment will be explained. In addition, the same reference numerals are used to denote the same parts as those explained in the first embodiment, and the description thereof will be omitted.

<Configuration of Attendee Management System>

As shown in FIG. 22, an attendee management system 100 according to the second embodiment is configured in such a way that a questionnaire processing unit 40 that performs questionnaire reception processing is connected via the network 8 as the communication network by wire or wirelessly, in addition to the configuration of the attendee management system 1 according to the first embodiment.

The exhibition site processing unit 7 includes, for example, an exhibition booth inner processing unit 71 for each of exhibition booths including a first exhibition booth to a sixth exhibition booth. The exhibition booth inner processing unit 71 is provided with a plurality of exhibition booth inner devices 7b. The exhibition booth inner devices 7b receives an input operation from an exhibition guide as an operator, or the attendee and performs storage processing for position information as attendee movement history and time information, in accordance with the input operation. In addition, the exhibition booth inner devices 7b function as a position registration device and a notification device.

The questionnaire processing unit 40 is, for example, provided with a plurality of questionnaire processing units 40a. The questionnaire processing unit 40 receives an input operation from the exhibition guide as an operator or the attendee, creates/displays questionnaire target items for attendees (questionnaire items) in accordance with the input operation and performs questionnaire result storage processing.

As each of these exhibition booth inner devices 7b and the questionnaire processing units 40a, an information processor 10 such as a personal computer (notebook personal computer, desktop personal computer) is used. The information processor 10 is the same as that used in the first embodiment.

Since the information storage device 3c in the backroom processing unit 3 functions as a database, the storage section 28 included in the information storage device 3c stores an exhibition booth visit history table 54, an exhibition booth code table 55, an exhibit table 56 and a questionnaire result table 57.

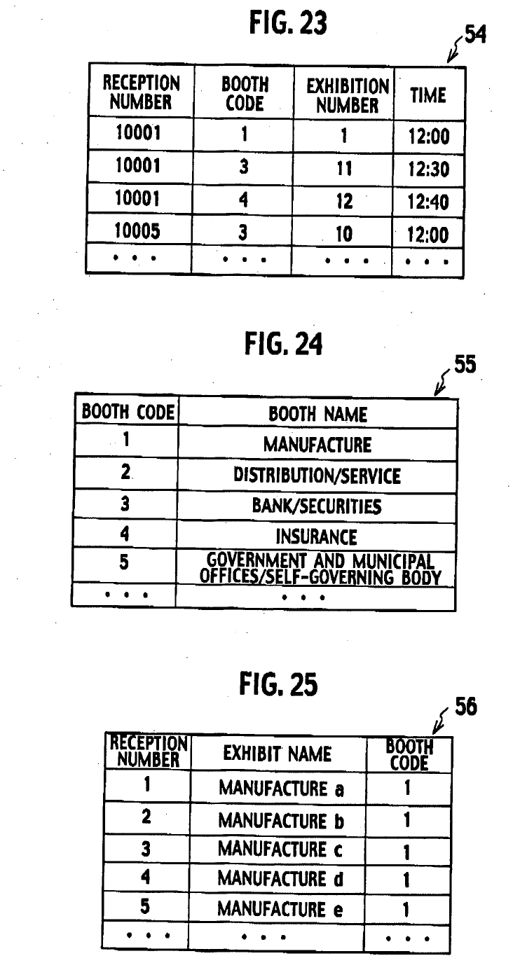

As shown in FIG. 23, the exhibition booth visit history table 54 stores exhibition history information which is part of the customer information, and which is exhibition booth visit information where the attendee has visited, for each attendee. The exhibition history information is composed of a reception number, a booth code and time, and is associated with the attendee management table 51 by the reception number.

As shown in FIG. 24, the exhibition booth code table 55 stores exhibition booth information on the exhibition booth. The exhibition booth information is composed of an exhibition booth code, an exhibition booth name and the like, while being associated with the exhibition booth visit history table 54 and the exhibit table 56 by the exhibition booth code. Additionally, the exhibition booth information is pre-registered in such an exhibition booth code table 55.

As shown in FIG. 25, in the exhibit table 56, exhibit information on exhibits is stored. The exhibit information is composed of an exhibit number uniquely added to each of all exhibits, an exhibit name and an exhibit booth code and the like, while being associated with the exhibition booth code table 55 and the exhibition booth visit history table 54 by the exhibition booth code. Additionally, in such an exhibit table, exhibit information is prestored.

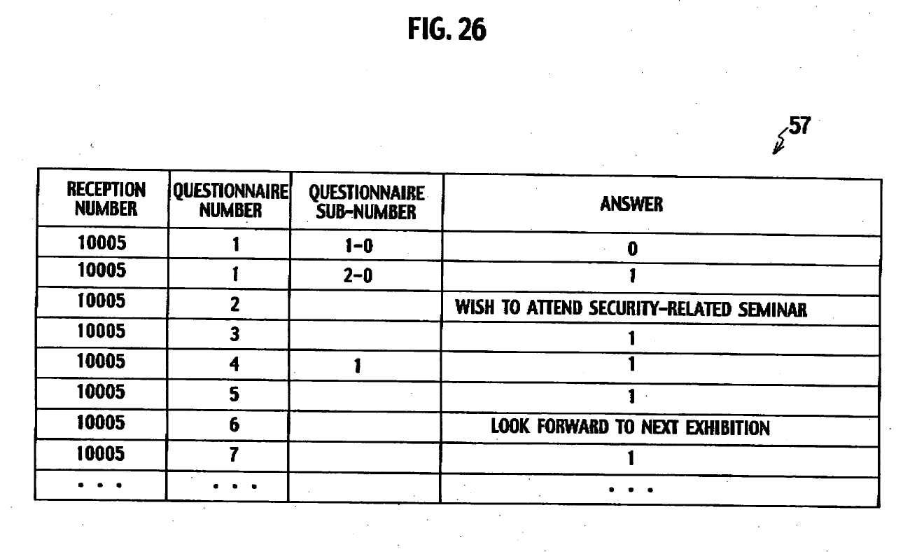

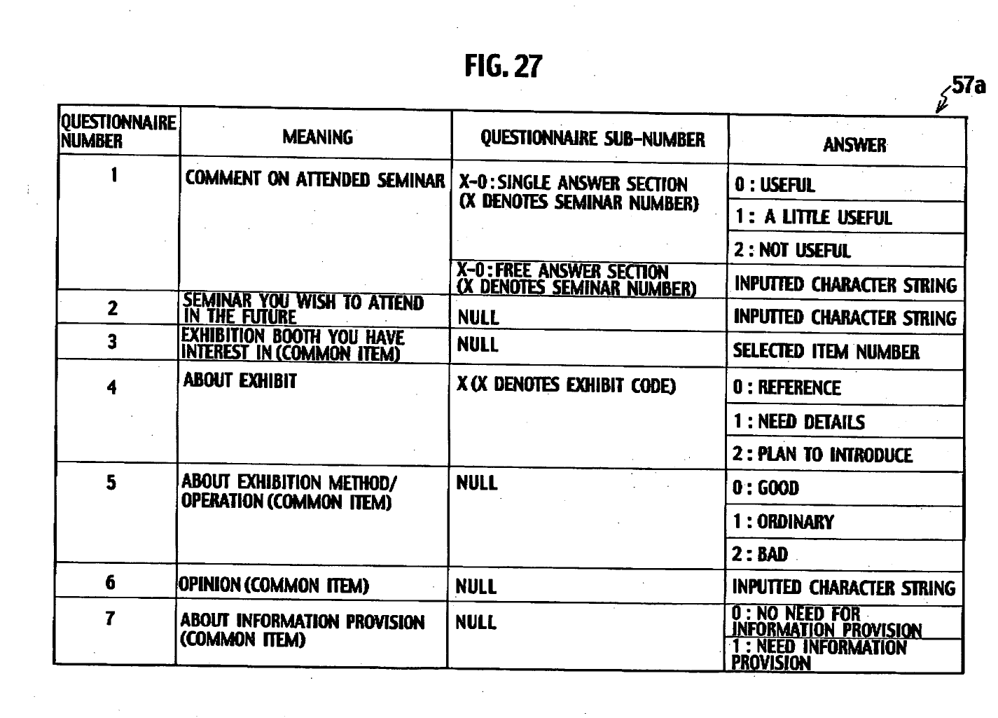

As shown in FIG. 26, in the questionnaire result table 57, questionnaire target items that the attendee answered and questionnaire result information on questionnaire results are stored for each attendee. The questionnaire result information is composed of a reception number, a questionnaire number indicating a type of questionnaire, a questionnaire sub-number indicating a type of answer and an answer, which are associated with the attendee management table 51 by the reception number. The questionnaire result table 57 is a table corresponding to a questionnaire result database structure 57a as shown in FIG. 27.

<Exhibition Booth Inner Processing>

An explanation will be next given of exhibition booth inner processing performed by the exhibition booth inner device 7b of the exhibition site unit 7. The CPU 21 of the exhibition booth inner device 7b executes exhibition booth inner processing using the attendee management program stored in the storage section 28 of the exhibition booth inner device 7b.

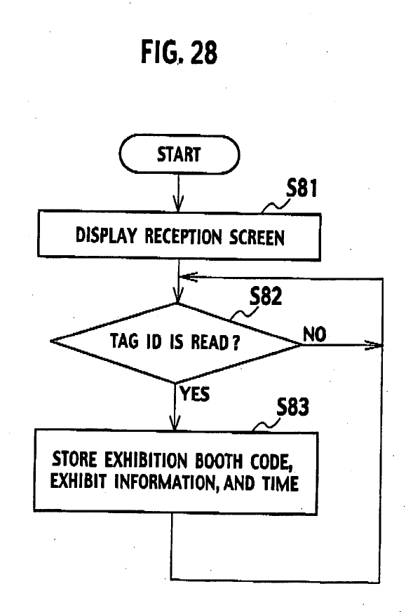

As shown in FIG. 28, the CPU 21 displays a reception screen on the display section 27 of the exhibition booth inner device 7b on starting the exhibition booth inner device 7b (step S81). Next, the CPU 21 determines whether or not the IC tag 32 is read by the exhibition booth inner device 7b (step S82) and waits for the reading of the IC tag 32 (N in step S82).

When determining that the IC tag 32 has been read (Y in step S82), the CUP 21 registers the read exhibition booth code, an exhibit number, and reading time as an attendee movement history location in the exhibition booth visit history table 54 (step S). Accordingly, the attendee movement history is registered.

<Questionnaire Processing>

An explanation will be next given of a questionnaire target item extraction and questionnaire answer processing performed by the questionnaire processing device 40a of the questionnaire processing unit 40. The CPU 21 of the questionnaire processing device 40a executes questionnaire processing using the attendee management program stored in the storage section 28 of the questionnaire processing device.

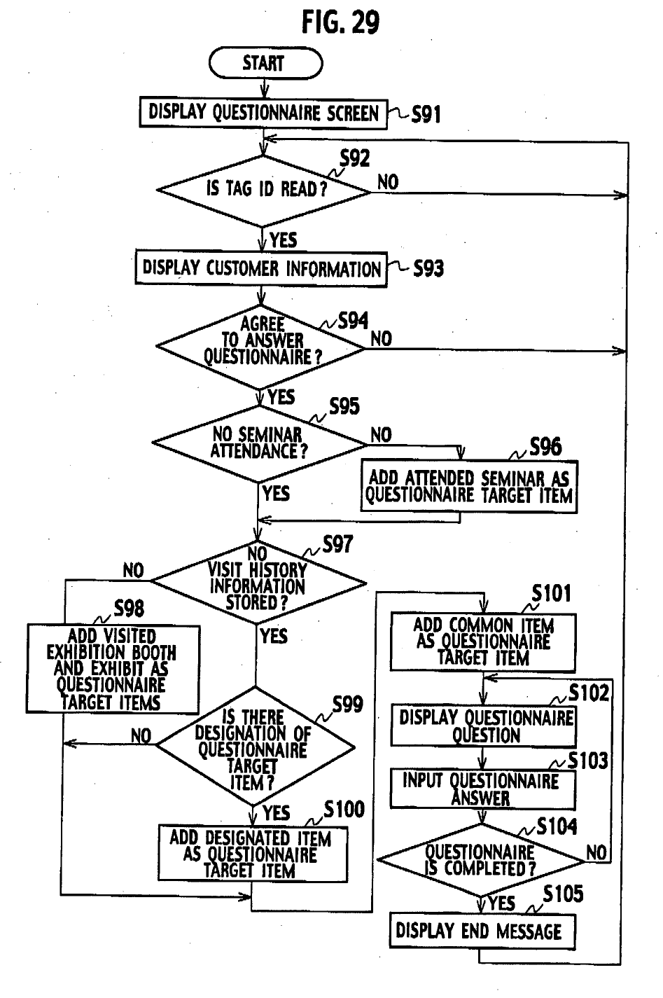

As shown in FIG. 29, the CPU 21 first displays a questionnaire screen on the display section 27 of the questionnaire processing device 40a on starting the questionnaire processing device 40a (step S91). Next, the CPU 21 determines whether or not the IC tag 32 is read by the questionnaire processing device 40a (step S92) and waits for the reading of the IC tag 32 (N in step S92).

When determining that the IC tag 32 has been read (Y in step S92), the CUP 21 reads attendee information in the attendee management table 51 in association with the tag ID read from the IC tag 32, and displays the attendee information on the questionnaire screen (step S93).

Subsequently, the CPU 21 confirms whether or not the attendee agrees to answer the questionnaire (step S94), and when determining that the attendee does not agree to answer the questionnaire (N in step S94), the CPU 21 terminates the questionnaire processing directly, and returns processing to step S92.

When determining that the attendee agrees to answer the questionnaire (Y in step S94), the CPU 21 displays the questionnaire target item. At this time, the CPU 21 checks whether or not the attendance status is “attended” by referring to the seminar management table 52 in association with the tag ID read from the IC tag 32 (step S95), and when determining that the attendance status is “attended” (N in step S95), the CPU 21 adds the attended seminar as a questionnaire target item in reference to the seminar code of the attended seminar (step S96).

Next, the CPU 21 determines whether or not the corresponding visit history information is stored by referring to the visit history table 54 in association with the tag ID read from the IC tag 32 (step S97). When determining that the corresponding visit history information is stored (N in step S97), the CPU 21 adds the visited exhibition booth and the exhibit as questionnaire target items (step S98). On the other hand, when determining that the corresponding visit history information is not stored (Y in step S97), the CPU 21 determines whether or not there is designation of questionnaire target item by the attendee (step S99).

When determining that there is no designation of questionnaire target item (N in step S99), the CPU 21 adds a questionnaire common item (see FIG. 27) as a questionnaire target item (step S101). On the other hand, when determining that there is designation of questionnaire target item (Y in step S99), the CPU 21 adds the exhibition booth and the exhibit designated by the attendee as questionnaire target items (step S101).

Thereafter, the CPU 21 displays the added questionnaire target item (questionnaire question) on the questionnaire screen (step S102), receives an answer input to the questionnaire by the attendee (step S103), determines whether or not the questionnaire is completed (step S104), and repeats step S102 and step S103 until the questionnaire is completed (N in step S104). When determining that the questionnaire is completed (Y in step S104), the CPU 21 displays an end message on the questionnaire screen (step S105) and returns processing to step S92.

<Effects of Second Embodiment>

As explained above, according to the second embodiment, it is possible to create questionnaire items adjusted to the attendee seminar attendance and exhibition booth visit history information, and therefore the attendee can answer the questionnaire in a short period of time and smoothly perform exit reception.

### Other Embodiments

It should be noted that, the present invention is not limited to the aforementioned embodiments, and that various changes may be made without departing from the spirit and scope of the invention.

For example, in the aforementioned embodiments, the simple information is composed of the name of the attendee, the company name, the department, however, the present invention is not limited to these, and for example, the simple information may be composed of the tile and the like in addition to the name of the attendee, the company name, the department, and is changed according to the salesperson's needs.

Moreover, in the aforementioned embodiments, the entrance reception device 2a issues the provisional advance application number, but the present invention is not limited to this, and for example, the provisional advance application number may not be issued. In this case, a flag or the like may be registered, indicating that the attendee is the proxy or the same-day applicant, as the customer information in the attendee management table 51.

In the aforementioned embodiments, the entrance reception device 2a copies the advance applicants company name, the telephone number, the address and the department as the customer information on the proxy and automatically registers them in the attendee management table 51, but the present invention is not limited to this, and for example, the entrance reception device 2a may copy the advance applicants name in addition to the advance applicant company name, the telephone number, the address and the department, to automatically register in the attendee management table 51.

In the aforementioned embodiments, the simple-input device 3a registers the simple information in the attendee management table 51 and the complete-input device 3b registers the complete information (detailed information) in the attendee management table 51, being separately registered in the attendee management table 51. However, the present invention is not limited to this, and for example, only the complete-input device 3b may be provided and the simple information and the complete information may not be separately registered, and only the complete-input device 3b may register the complete information in the attendee management table 51.

In the aforementioned embodiments, the entrance notification device 5a notifies the salesperson's mobile terminal 9 of the customer information on the attendee in response to the entrance reception of the attendee, while the attendee display device 5c displays the customer information on the attendee on the attendee screen G4, thereby notifying the salesperson of the entrance of the attendee. However, the present invention is not limited to this, and for example, any one of the two may be performed and the entrance of the attendee may be reported by sound. Similarly, the exhibition site device 7a notifies the salesperson's mobile terminal 9 of the attendee location in response to the position information on the attendee location, while displaying the attendee location on the attendee screen G4, thereby notifying the salesperson of the attendee location. However, the present invention is not limited to this, and for example, any one of the two may be performed and the attendee location may be reported by sound.

In the aforementioned embodiments, the exhibition site device 7a is used as the position registration device and the notification device, however, the present invention is not limited to this, and for example, it is possible to use the entrance reception device 2a, the exit reception device 4a and the seminar reception device 6a as the position registration device and the notification device.

In the aforementioned embodiments, the seminar reception device 6a displays the message M on the seminar reception screen G5, thereby notifying that the seminar site is wrong. However, the present invention is not limited to this, and for example, it is possible to notify that the seminar site is wrong by an output of sound.

### INDUSTRIAL APPLICABILITY

Though the above has explained the embodiments of the present invention, this simply illustrates the specific examples and does not particularly restrict the present invention, and the specific configuration of each part may be appropriately changed. Moreover, regarding the functions and effects described in the embodiments, the most appropriate functions and effects resulting from the present invention are simply listed and the functions and effects of the present invention are not restricted to those described in the embodiments of the present invention. The present invention is used in event sites such as an exhibition site, a seminar site and the like, that is, sites where the attendee entrance and exit are managed.

What is claimed is:

1. An attendee management method comprising the steps of;
determining the presence or absence of input of advance application information issued in advance in association with customer information;
receiving input of identification information for identifying a wireless tag handed to an attendee;
registering the advance application information and the identification information as entrance information in a database in association with each other when it is determined that the input of the advance application information is present; and
registering the identification information as entrance information in the database when it is determined that the input of the advance application information is absent.

2. The attendee management method according to claim 1, wherein in the step of registering the identification information in the database, when it is determined that the input of the advance application information is absent, provisional advance application information is issued in place of the advance application information, and the provisional prior information and the identification information are registered as entrance information in the database in association with each other.

3. The attendee management method according to claim 1, further comprising the step of associating the identification information with specific information specific to the wireless tag.

4. The attendee management method according to claim 3, wherein the identification information has an amount of information smaller than that of the specific information.

5. The attendee management method according to claim 1, further comprising the steps of:
determining the presence or absence of input of declaration that the attendee is a proxy; and
registering the customer information in the database in association with the identification information when it is determined that the input of the advance application information is present and that the input of declaration that the attendee is a proxy is present.

6. The attendee management method according to claim 1, further comprising the step of receiving input of the customer information on the attendee in association with the identification information registered in the database.

7. The attendee management method according to claim 6, wherein in the step of receiving the input of the customer information on the attendee in association with the identification information registered in the database, input of simple information on the attendee and input of detailed information thereof are received separately.

8. The attendee management method according to claim 7, further comprising the step of displaying the simple information.

9. The attendee management method according to claim 7, further comprising the step of transmitting the simple information to a mobile terminal that the attendee carries.

10. The attendee management method according to claim 1, further comprising the step of registering position information on a location of the attendee as customer information on the attendee, in the database in association with the identification information of the wireless tag that the attendee carries.

11. The attendee management method according to claim 10, further comprising the step of displaying the position information.

12. The attendee management method according to claim 10, further comprising the step of transmitting the position information to the mobile terminal that the attendee carries.

13. The attendee management method according to claim 1, further comprising the step of registering position information on movement history of the attendee as customer information on the attendee, in the database in association with the identification information of the wireless tag that the attendee carries.

14. The attendee management method according to claim 1, wherein the customer information includes seminar information on a seminar that the attendee attends, further comprising the step of displaying the seminar information corresponding to the identification information of the wireless tag that the attendee carries.

15. The attendee management method according to claim 14, wherein the seminar information includes vacancy information on a site where the seminar is held.

16. The attendee management method according to claim 15, further comprising the step of permitting attendance at the seminar with available seats on the same day of attendance, in reference to the vacancy information.

17. The attendee management method according to claim 14, further comprising the steps of:
determining whether or not a site where the attendee is present is the site where the seminar is held, in reference to the seminar information corresponding to the identification information of the wireless tag that the attendee carries; and
notifying that the site where the attendee is present is not the site where the seminar is held, when it is determined that the site where the attendee is present is not the site where the seminar is held.

18. The attendee management method according to claim 1, further comprising the step of extracting a questionnaire target item in reference to the customer information corresponding to the identification information of the wireless tag that the attendee carries.

19. The attendee management method according to claim 18, wherein the customer information includes seminar information on a seminar that the attendee attends, and in the step of extracting the questionnaire target item, the questionnaire target item is extracted in reference to the seminar information corresponding to the identification information of the wireless tag that the attendee carries.

20. The attendee management method according to claim 15, wherein the customer information includes exhibition history information where the attendee has visited, and in the step of extracting the questionnaire target item, the questionnaire target item is extracted in reference to the exhibition history information corresponding to the identification information of the wireless tag that the attendee carries.

21. An attendee management system comprising
a database;
a reception device including:
an input section configured to receive input of advance application information issued in advance in association with customer information, and input of identification information for identifying a wireless tag handed to an attendee;
determination means configured to determine the presence or absence of input of advance application information issued in advance in association with customer information; and
registration means configured to register the advance application information and the identification information as entrance information in the database in association with each other when it is determined that the input of the advance application information is present, and to register the identification information as entrance information in the database when it is determined that the input of the advance application information is absent.

22. The attendee management system according to claim 21, wherein when it is determined that the input of the advance application information is absent, the registration means issues provisional advance application information in place of the advance application information, and registers the provisional prior information and the identification information as entrance information in the database in association with each other.

23. The attendee management system according to claim 21, wherein the reception device further includes association means configured to associate the identification information with specific information specific to the wireless tag.

24. The attendee management system according to claim 23, wherein the identification information has an amount of information smaller than that of the specific information.

25. The attendee management system according to claim 21, wherein the reception device further includes declaration input determination means configured to determine the presence or absence of input of declaration that the attendee is a proxy, characterized in that the registration means registers the customer information in the database in association with the identification information, when it is determined that the input of the advance application information is present and that the input of declaration that the attendee is a proxy is present.

26. The attendee management system according to claim 21, further comprising an input device configured to receive input of the customer information on the attendee in association with the registered identification information.

27. The attendee management system according to claim 26, wherein the input device receives input of simple information on the attendee and input of detailed information thereof, separately.

28. The attendee management system according to claim 27, further comprising a display device configured to display the simple information.

29. The attendee management system according to claim 27, further comprising a notification device configured to transmit the simple information to a mobile terminal that the attendee carries.

30. The attendee management system according to claim 21, further comprising a position registration device configured to register position information on a location of the attendee as customer information on the attendee in the database in association with the identification information of the wireless tag that the attendee carries.

31. The attendee management system according to claim 30, further comprising a display device configured to display the position information.

32. The attendee management system according to claim 30, further comprising a notification device configured to transmit the position information to the mobile terminal that the attendee carries.

33. The attendee management system according to claim 21, further comprising a position registration device configured to register position information on movement history of the attendee as customer information on the attendee in the database, in association with the identification information of the wireless tag that the attendee carries.

34. The attendee management system according to claim 21, wherein the customer information includes seminar information on a seminar that the attendee has attended, further comprising a display device configured to display the seminar information corresponding to the identification information of the wireless tag that the attendee carries.

35. The attendee management system according to claim 34, wherein the seminar information includes vacancy information on a site where the seminar is held.

36. The attendee management system according to claim 35, further comprising a seminar reception device configured to permit attendance at the seminar with available seats on the same day of attendance in reference to the vacancy information.

37. The attendee management system according to claim 34, further comprising:
site determination means configured to determine whether or not a site where the attendee is present is the site where the seminar is held in reference to the seminar information corresponding to the identification information of the wireless tag that the attendee carries; and
notification means configured to notify that the site where the attendee is present is not the site where the seminar is held, when it is determined that the site where the attendee is present is not the site where the seminar is held.

38. The attendee management system according to claim 21, further comprising a questionnaire processing device configured to extract a questionnaire target item in reference to the customer information corresponding to the identification information of the wireless tag that the attendee carries.

39. The attendee management system according to claim 38, wherein the customer information includes seminar information on a seminar that the attendee has attended, and the questionnaire processing device extracts the questionnaire target item in reference to the seminar information corresponding to the identification information of the wireless tag that the attendee carries.

40. The attendee management system according to claim 38, wherein the customer information includes exhibition history information where the attendee has visited, and the questionnaire processing device extracts the questionnaire target item in reference to the exhibition history information corresponding to the identification information of the wireless tag that the attendee carries.
